(19) United States
(12) Patent Application Publication
(10) Pub. No.: US 2012/0175392 A1
(43) Pub. Date: Jul. 12, 2012

(54) Body Securement Apparatuses, Swivel Connecting Devices and Methods for Securing Structures to a Body

(76) Inventor: JERRY D. ELY, Potlatch, ID (US)

(21) Appl. No.: 13/005,011

(22) Filed: Jan. 12, 2011

(51) Int. Cl. A45F 3/14; F41C 33/00; F16C 11/04

(52) U.S. Cl. 224/259; 403/119

(57) ABSTRACT

A body securement apparatus that includes a length of flexible material configured to be supported upon a body. The length of flexible material includes a first connector having a first end spaced from a second end. The first end is secured to the length of flexible material and the second end is configured to be secured to a structure to be carried upon the body. The length of flexible material further includes a second connector having a first end spaced from a second end. The first end of the second connector slidingly engages the length of flexible material and the second end of the second connector is configured to be secured to a structure to be carried upon the body.

### CROSS REFERENCE TO RELATED APPLICATION

This application does not claim priority from any other application.

### TECHNICAL FIELD

This invention relates to body securement apparatuses, swivel connecting devices and methods for securing structures to a body.

### BACKGROUND OF THE INVENTION

Apparatuses and devices for securing structures, such as firearms, hunting devices and/or storage containers, to a body of an individual continually need to be designed to improve the capability for individuals to carry the structure(s) while moving freely, unencumbered, and allowing the individual to accomplish other tasks seamlessly. For example, for individuals needing to carry firearms such as police, military personnel and hunters, there is a need to move through their respective environments silently with the capability of bringing a firearm to a firing position safely, quickly and efficiently from a storage or carrying position. Devices to facilitate this goal must allow the firearms to be moved effortlessly, silently and most importantly, safely. Accordingly, there always is a need to provide new designs and configurations for apparatuses and devices to secure structures such as firearms to an individual's body which will accomplish these goals.

### BRIEF DESCRIPTION OF THE DRAWINGS

Preferred embodiments of the invention are described below with reference to the following accompanying drawings.

FIG. 1 is a perspective view of an exemplary body securement apparatus according to one of various embodiments of the invention.

FIG. 2 is a perspective view of another exemplary body securement apparatus according to another one of various embodiments of the invention.

FIG. 3 is a front view of an exemplary swivel connecting device according to one of various embodiments of the invention.

FIG. 4 is a partial cut-away view of the exemplary swivel connecting device of FIG. 3 and illustrated in one method step of use according to one of various embodiments of the invention.

FIG. 5 is the exemplary swivel connecting device of FIG. 3 view illustrated in another method step of use according to one of various embodiments of the invention.

FIG. 6 is a side view of the exemplary swivel connecting device of FIG. 3 and illustrated in one method step of use according to one of various embodiments of the invention.

FIG. 7 is a side view of the exemplary swivel connecting device of FIG. 3 and illustrated in another method step of use according to another of various embodiments of the invention.

FIG. 8 is a perspective view of an exemplary body securement apparatus in one method of use according to one of various embodiments of the invention.

FIG. 9 is a perspective view of an exemplary body securement apparatus in another method of use according to another of various embodiments of the invention.

FIG. 10 is a close-up view of a portion of the FIG. 9 view.

FIG. 11 is a perspective view of another exemplary body securement apparatus according to another of various embodiments of the invention.

FIG. 12 is the exemplary body securement apparatus of FIG. 11 illustrated in one method step of use according to one of various embodiments of the invention.

FIG. 13 is a perspective view of another exemplary body securement apparatus according to another of various embodiments of the invention.

FIG. 14 is a perspective view of another exemplary body securement apparatus according to another of various embodiments of the invention.

FIG. 15 is a perspective view of another exemplary body securement apparatus according to another of various embodiments of the invention.

FIG. 16 is a perspective view of another exemplary body securement apparatus according to another of various embodiments of the invention.

FIG. 17 is the exemplary body securement apparatus of FIG. 16 illustrated in one method step of use according to one of various embodiments of the invention.

FIG. 18 is a perspective view of another exemplary body securement apparatus according to another of various embodiments of the invention.

FIGS. 19 and 20 are fragmentary views of still another body securement apparatus according to another of various embodiments of the invention.

FIG. 21 is the exemplary body securement apparatus of FIGS. 19 and 20 illustrated in one method step of use according to one of various embodiments of the invention.

FIG. 22 is a front view of another exemplary swivel connecting device according to another of various embodiments of the invention.

FIG. 23 is a partial cut-away view of the exemplary swivel connecting device of FIG. 22 and illustrated in one method step of use according to one of various embodiments of the invention.

FIG. 24 is the exemplary swivel connecting device of FIG. 23 view illustrated in another method step of use according to another of various embodiments of the invention.

FIG. 25 is the exemplary swivel connecting device of FIG. 23 view illustrated in still another method step of use according to another of various embodiments of the invention.

FIG. 26 is a partial cut-away of a front view of another exemplary swivel connecting device according to another of various embodiments of the invention.

FIG. 27 is the exemplary swivel connecting device of FIG. 26 illustrated in another method step of use according to another of various embodiments of the invention.

FIG. 28 is the exemplary swivel connecting device of FIG. 26 illustrated in still another method step of use according to still another of various embodiments of the invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

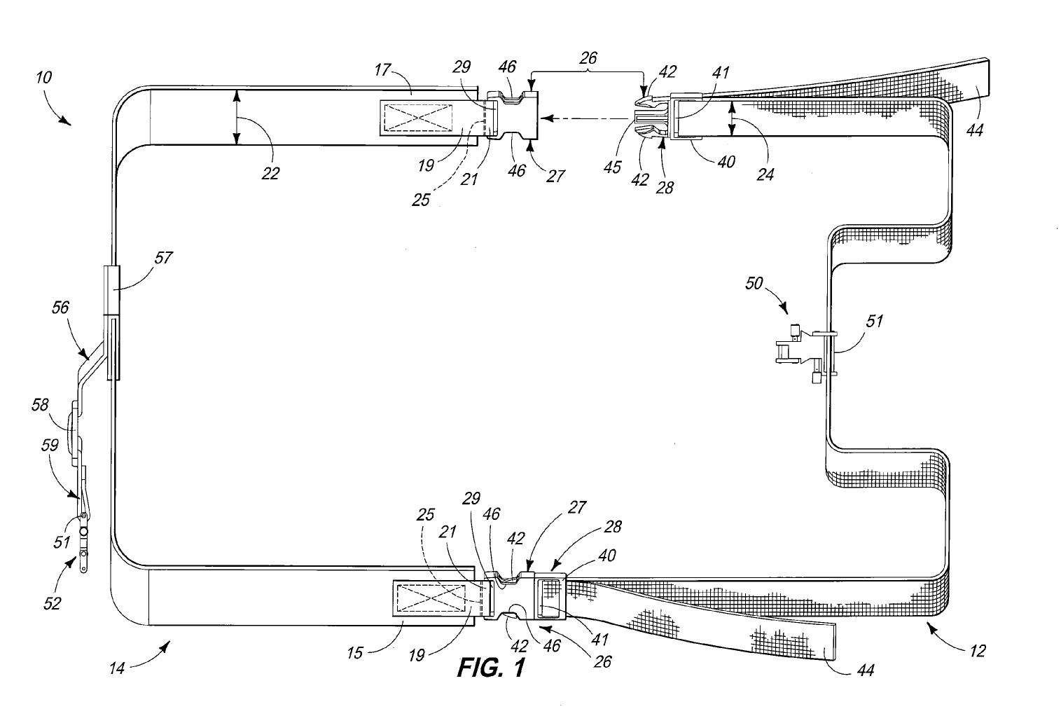

Referring to FIG. 1, an exemplary body securement apparatus 10 (also can be referred to as a body attachment apparatus or firearm securement apparatus) to secure a structure, such as a hunting device, to an individual's body is illustrated according to one of various embodiments of the invention. Exemplary apparatuses or devices 10 can be referred to as slings, straps and/or supports for structures such as firearms, archery bows and storage containers (effectively, any item that an individual desires to carry or support upon the body). Apparatus 10 includes a first strap 12 and a second strap 14 configured to be secured together. Each first and second strap 12 and 14 is an elongated rectangular strip of flexible material (compositions of flexible material described more thoroughly subsequently) with opposite ends configured to allow ends of strap 12 be secured to ends of strap 14. For example, each end of each exemplary strap 12 and 14 has either a male element 28 or an female element 27 of a fastener 26 that allows for straps 12 and 14 to be selectively secured to, and selectively disconnected from, each other. Other exemplary fasteners include various designs and configurations of snaps, connectors, buckles and/or clasps. The fasteners 26 shown have the female element 27 configured as a housing surrounding an opening to receive a portion of the male element 28.

It should be understood that while the present embodiment of the body securement apparatus 10 is shown having two straps 12 and 14, another exemplary embodiment of a body securement apparatus would include a single strap or a single length of flexible material with opposite ends. One end would have either a male or female element of a fastener and the other end would have the other of either a male or female element so the ends could be interlocked to form a loop of flexible material. It should further be understood that while the present embodiment of apparatus 10 is shown with each end of strap 12 having a male element 28 of fastener 26 and with each end of strap 14 having a female element 27 of fastener 26, other embodiments are contemplated. For example, other exemplary straps 12 can have a female element 27 provided at respective ends and other exemplary straps 14 can have a male element 28 provided at respective ends. Still further, strap 12 can have a male element 28 at either of only one end and a female element 27 at the other end of strap 12. In operational cooperation, strap 14 can have a male element 28 at either of only one end and a female element 27 at the other end of strap 14.

Still referring to FIG. 1, opposite ends 15 and 17 of exemplary strap 14 of apparatus 10 include an attachment strip 19 sown or stitched into the ends 15 and 17. Each attachment strip 19 comprises flexible material and is a bifurcated configuration having two portions with one portion being sown or stitched to one side of second strap 14 and the other portion being sown or stitched to the other side of second strap 14. It should be understood that attachment strips 19 could be sown or stitched to only one side of second strap 14. Still further, each attachment strip 19 extends outwardly from respective ends 15 and 17 of second strap 14 to terminate with a loop configuration 21 for securement to a portion of a fastener device such as fastener 26. In this example, the portion of the fastener 26 is a female element 27. Exemplary loops 21 of respective attachment strips 19 are received through an opening 29 of each female element 27, and in the present embodiment, to surround a cross member or crossbar (not seen) thereby securing respective ends 15 and 17 of second strap 14 to respective female elements 27. Additional stitching 25 is provided in respective attachment strips 19 proximate the female elements 27 to decrease the diameters of respective loops 21.

Still referring to FIG. 1, exemplary male elements 28 of fasteners 26 are fitted or slide over portions of strap 12 for sliding engagement and adjustment relative respective opposite ends 44 of first strap 12. That is, each male element 28 includes a rear portion that is a buckle portion 40 to provide the sliding and positioning adjustment capabilities of male element 28 along any position of strap 12 relative ends 44. The cooperation and sliding engagement of a strap (or strip of material) through a buckle to provide the sliding and positioning adjustment capabilities will allow an individual to adjust, that is lengthen or shorten, an exemplary body securement apparatus 10 to fit the individual's body size for comfort and ease of use.

Still referring to FIG. 1, an exemplary male element 28 of fastener 26 includes a front portion extending from the buckle portion 40. The front portion of male element 28 is a locking mechanism for selectively releasing and locking the male element 28 to female element 27 of fastener 26. An exemplary front portion of male element 28 includes an optional tongue 45 positioned between a pair of lateral latches 42. Each lateral latch 42 extends forwardly in a linear and parallel configuration from the buckle portion 40. The lateral latches 42 are resilient material allowing for end portions with tabs to move laterally inwardly and outwardly. The tongue 45 facilitates the guidance of lateral latches 42 into female elements 27. Moreover, each female element 27 has opposite lateral sides with inwardly indented portions 46 which lead into the opening of female elements 27.

Still referring to FIG. 1, an exemplary attachment operation or method for securing male element 28 to female element 27 of fastener 26, the front portion of male element 28 is positioned to move through an end of female element 27 through the opening. During the movement of the front portion of male element 28 through female element 27, the tabs of lateral latches 42 of male element 28 engage inner walls of the female element 27 to move laterally inward toward tongue 45. The movement is continued until the inner walls of female element 27 give way to indented portions 46 (open to the environment) wherein the tabs of male element 28 no longer engage female element 27 and spring laterally outward from tongue 45 until the tabs rest positioned in and exposed through the indented portions 46 of female element 27. In this orientation of respective female and male elements 27 and 28, the male element 28 is locked into the female element 27 which effectively locks one end 17 of second strap 14 to one end or section 44 of first strap 12.

It should be understood that securing each male element 28 to each female element 27 of respective straps 12 and 14 effectively locks ends 15 and 17 of strap 14 to respective adjusted ends of strap 12 to establish a flexible loop of material which forms a portion of the body securement apparatus 10 in the locked or closed configuration.

To begin unlocking or releasing the fastener 26, the tabs of lateral latches 42 of male element 28 which are exposed through indented portions 46 of female element 27 are manipulated inward until the tabs are released from female element 27. With the tabs oriented in this position, the male element 28 can be pulled away from the female element 27 until the front portion of male element 28 is no longer in the opening of the female element 27. In this orientation of respective female and male elements 27 and 28, the male element 28 is released from the female element 27 which effectively unlocks one end, 15 or 17, of second strap 14 from one end of first strap 12.

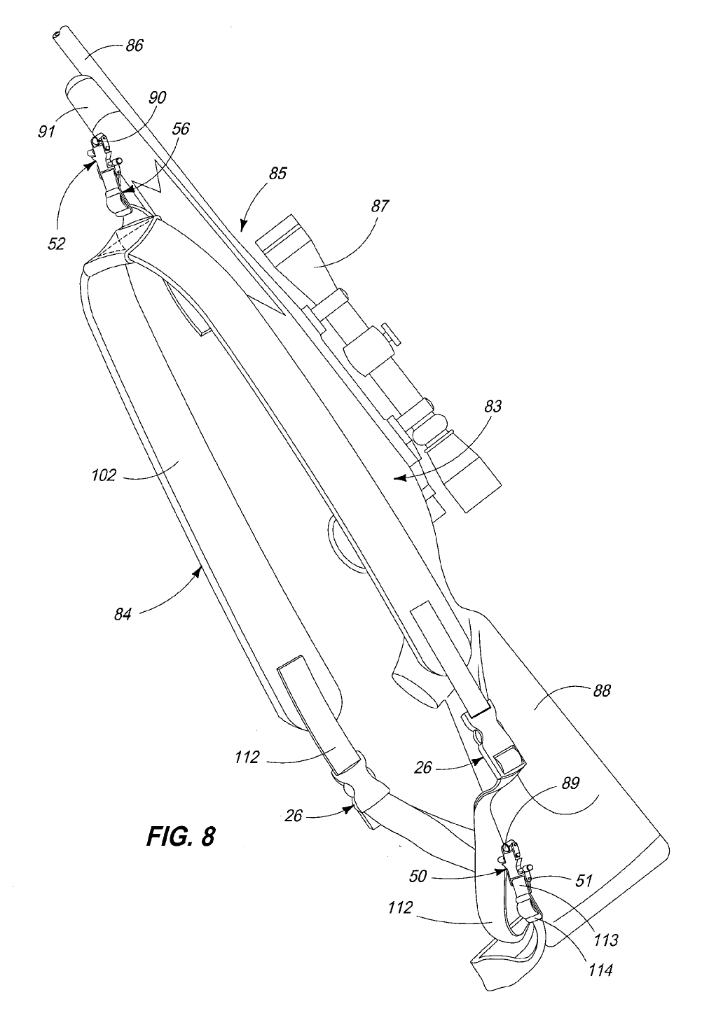

Still referring to FIG. 1, exemplary embodiments for inventive apparatuses 10 include an adjustable strip 56 extending from only one (either one) or both, of straps 12 and 14. An exemplary body securement apparatus 10 includes an adjustable strip 56 secured to and extending from generally a central portion of strap 14. Adjustable strip 56 is flexible material and can be the same material as the material of one of straps 12 and 14, and alternatively, material of strip 56 can be different material relative straps 12 and 14. The exemplary adjustable strip 56 is secured to second strap 14 by, for example, a stitched patch 57. An exemplary stitched patch 57 comprises leather material with at least one purpose is to strengthen the attachment of adjustable strip 56 to second strap 14. Other exemplary materials for patch 57 include having the same material as strap 14, or other different materials discussed subsequently. It should be understood that structures to be secured to an individual's body with exemplary body securement apparatuses 10 will have mounts, such as swivel mounts on firearms, bows and/or storage structures (see swivel mounts 89 and 90 in FIG. 8). Some structures will have only one mount, while others have two mounts. One or more of the mounts can comprise the capability to rotate on an axis generally perpendicular to a longitudinal axis of the structure. Ultimately, adjustable strip 56 will be secured to a mount, such as a swivel mount, as explained subsequently.

Still referring to FIG. 1, an exemplary adjustable strip 56 includes a loop 59 to receive a connector device (or connector) 52 wherein the connector device 52 will attach adjustable strip 56 of body securement apparatus 10 to a mount on a firearm. The exemplary loop 59 can be a separate structure attached to the adjustable strip 56 or integral with the material of the adjustable strip 56 wherein the material forms the loop 59. For another embodiment, an exemplary connector device includes a ring (not shown) that is secured to the adjustable strip 56 and can be secured to a mount on a firearm. Still another embodiment includes loop 59 secured to or integral with adjustable strip 56 and attached directly to the mount on a firearm. In yet another embodiment for body securement apparatus 10, an exemplary connector includes the swivel connecting device 52 that is secured to the adjustable strip 56 and is configured to be selectively secured to the firearm mount. In one exemplary embodiment, the adjustable strip 56 includes a loop to be secured over a cross bar 51 of swivel connecting device 52. In one exemplary embodiment of body securement apparatus 10, the exemplary adjustable strip 56 further includes a buckle 58 to provide selective length adjustment capabilities for the adjustable strip 56.

Exemplary embodiments for inventive body securement apparatus 10 include exemplary various materials for the various elements such as the straps 12 and 14, attachment strip 19, adjustable strip 56 and patch 57. The various exemplary materials include various nylon materials, various thermoplastic polyamides capable of extrusion into or onto fibers and sheets, various cloth or threaded materials, various rubber materials, neoprene, polychloroprene and/or leather. For any one exemplary body securement apparatus 10, various different combinations of various materials are included for straps 12 and 14, attachment strip 19, adjustable strip 56 and patch 57. For one exemplary embodiment, the materials are the same for each element. For another embodiment, straps 12 and 14 are the same material while a different material is used for at least the attachment strip 19 and the adjustable strip 56.

Still referring to FIG. 1, still another embodiment of body securement apparatus 10 includes an exemplary material for strap 12 as being different from the material for strap 14, with the material for attachment strip 19 and adjustable strip 56 as being the same as at least one of straps 12 and 14. Alternatively, another embodiment includes the material being different for each of straps 12 and 14, attachment strip 19 and adjustable strip 56. Yet another embodiment of apparatus 10 includes the material for each of straps 12 and 14 as being nylon web material while the material(s) for attachment strip 19 and adjustable strip 56 includes any one of the materials discussed above. In the exemplary embodiment of inventive body securement apparatus 10 shown in FIG. 1, first strap 12 comprises a nylon material, second strap 14 comprises a rubber material, attachment strip 19 and adjustable strip 56 comprise nylon material.

Still further, exemplary body securement apparatuses 10 include respective straps 12 and 14 having various combinations of widths and lengths. For example, first strap 12 has a width 24 which is less than a width 22 for second strap 14. Alternatively, first strap 12 has a width dimension which is greater than a width dimension for second strap 14. Still further, an exemplary first strap 12 has a width dimension which is the same as a width dimension for exemplary second strap 14. Exemplary width dimensions include 0.1 inch, 0.2 inch, 0.3 inch . . . up to 8 inches including any width of any tenth of an inch between 0.3 inch and 8 inches. An exemplary width 24 for first strap 12 is one inch. An exemplary width 22 for second strap 14 is two inches. Regarding length dimensions, exemplary embodiments of inventive body securement apparatuses 10 include respective straps 12 and 14 having the same length dimension. Alternatively, an exemplary first strap 12 has a length dimension greater than a length dimension for an exemplary second strap 14. Still further, an exemplary first strap 12 has a length dimension which is less than a length dimension for second strap 14. Exemplary length dimensions include 1 foot up to 10 feet including any length of any inch between 1 foot and 10 feet. An exemplary length for first strap 12 is 48 inches. An exemplary length for second strap 14 is 38 inches.

Exemplary body securement apparatuses 10 include embodiments having only one connector, that is, the one swivel connecting device 52 discussed previously. Alternatively, referring to FIG. 1, other exemplary embodiments of the invention include body securement apparatuses 10 having two connectors with each being configured to be secured to one of two different locations on a firearm. An exemplary first swivel connecting device 50 is secured to apparatus 10 on strap 12 while the swivel connecting device 52 is secured to strap 14 as previously discussed and can be termed the second swivel connecting device 52. In this embodiment shown, first swivel connecting device 50 slidingly engages strap 12. As another exemplary embodiment of body securement apparatus 10, first swivel connecting device 50 is secured to strap 12 via a length of material similar to the adjustable strip 56 for second swivel connecting device 52. Alternatively, another exemplary embodiment of body securement apparatus 10 includes the second swivel connecting device 52 being directly attached to the first strap 12. Still further, another exemplary embodiment of body securement apparatus 10 includes the second swivel connecting device 52 slidingly engaging the first strap 14 with strap 14 extending through an opening in swivel connecting device 52.

It should be understood that exemplary embodiments for inventive body securement apparatus 10 include the respective first and second swivel connecting devices 50 and 52 as having the same connector design and configuration. Alternatively, it should be understood that exemplary embodiments for inventive body securement apparatus 10 include the respective first and second swivel connecting devices 50 and 52 as having different connector designs and configuration.

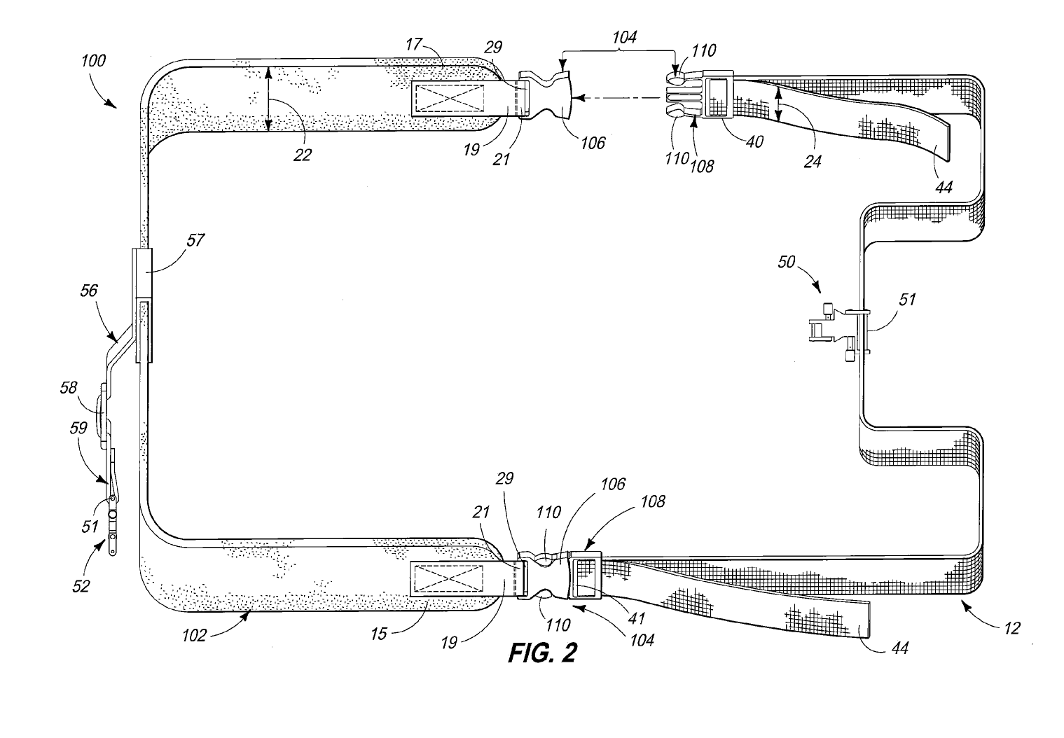

Referring to FIG. 2, another exemplary body securement apparatus 100 is illustrated according to another of various embodiments of the invention. Structures and configurations of body securement apparatus 100 that have been described previously are referenced with the same reference number as previously used. An exemplary body securement apparatus 100 includes a second strap 102 that is configured with a different composition of material than the second strap 14 of FIG. 1 described previously. For example, an exemplary second strap 102 comprises a neoprene material. As described subsequently, exemplary embodiments of methods for using the body securement apparatuses described throughout this document include having the second strap provided over the shoulders of individuals. Accordingly, using neoprene material for second strap 102 rather than other materials can diminish shoulder fatigue that can occur when heavy loads are carried by individual via the exemplary body securement apparatus and/or when any load is carried for a long length of time. The neoprene material acts as a cushion or shock absorber between the shoulders and the weight being carried by the body securement apparatuses.

Still referring to FIG. 2, body securement apparatus 100 includes a fastener 104 that is this differently configured relative fastener 26 for body securement apparatus 10 described previously. An exemplary fastener 104 includes a male element 108 that can be fitted to a female element 106. An exemplary female element 106 is configured to be differently shaped relative the shape of female element 27 for body securement apparatus 10 described previously. The differently shaped female element 106 can facilitate finger manipulation of fastener 104 relative finger manipulation of other shape configurations for exemplary female elements. Moreover, male element 108 includes two lateral latches 110 that are configured to be differently shaped relative the shape of lateral latches 42 for male element 28 for body securement apparatus 10 described previously. The differently shaped two lateral latches 110 facilitate the securement of male elements 108 to the differently shaped female elements 106.

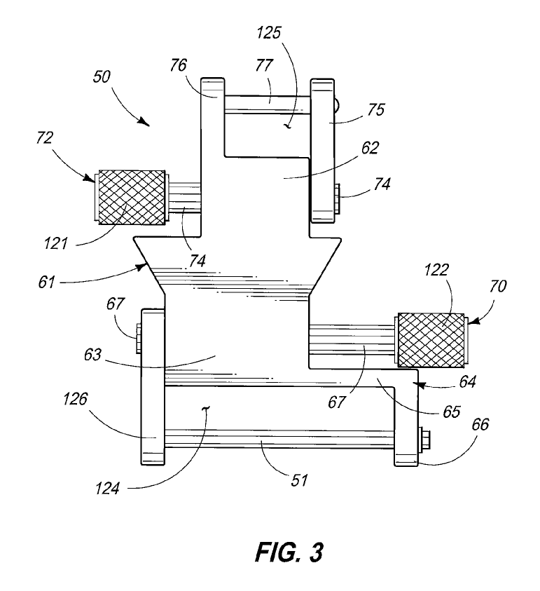

Referring to FIG. 3, an exemplary first swivel connecting device (connector or connecting device) 50 is more thoroughly described and illustrated according to one of various embodiments of the invention. It should be understood that the discussion and description for first swivel connecting device 50 is also applicable to some embodiments of second swivel connecting device 52. An exemplary first swivel connecting device 50 includes a main body 61 having a composition of plastic, metal, metal alloy, thermoplastic and/or combination of any composition listed. Main body 61 has a first end 62 opposite a second end 63. First end 62 of main body 61 has an extension arm 76 having a linear shape and receives a first interlocking mechanism 72. One end of a cross bar 77 is affixed to, and extends perpendicularly from, one side of extension arm 76. An exemplary second end 63 of main body 61 receives a second interlocking mechanism 70 and includes an extension arm 64 having an L-shaped configuration. An exemplary extension arm 64 comprises a base portion 65 extending perpendicularly from an extension portion 66. One end of a cross bar 124 is affixed to, and extends perpendicularly from, one side of extension portion 66 of the extension arm 64.

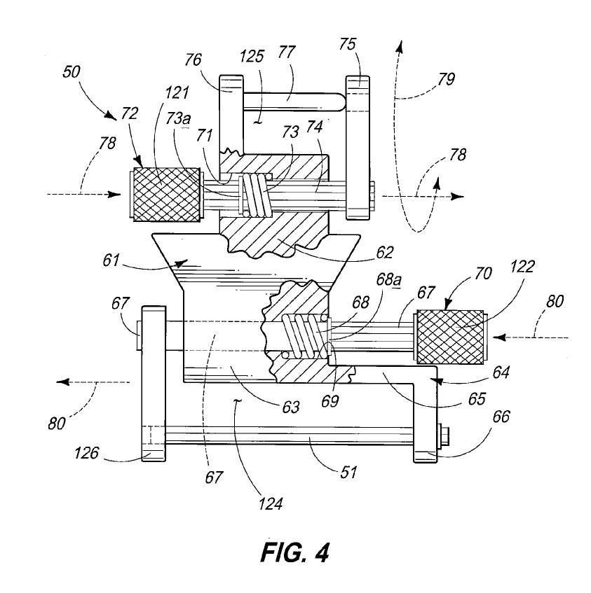

Still referring to FIG. 3, an exemplary embodiment for first interlocking mechanism 72 includes a rotation pin 74 extending longitudinally through an opening (see FIG. 4) in first end 62 of the main body 61 of the first swivel connection device 50. One end of rotation pin 74 extends from one side of first end 62 and has a grip 121 configured for finger manipulation. An opposite end of rotation pin 74 extends from an opposite side of first end 62 and is affixed to one end of a rotation lever 75 (also can be referred to as a locking lever or an opening lever). An opposite end of rotation lever 75 has an opening to receive an end of cross bar 77 opposite from the extension arm 76. Collectively, a portion of first end 62, rotation lever 75, extension arm 76 and cross bar 77 establish an opening 125.

Still referring to FIG. 3, an exemplary embodiment for second interlocking mechanism 70 includes a rotation pin 67 extending longitudinally through an opening in second end 63 of the main body 61 of the first swivel connection device 50. One end of rotation pin 67 extends from one side of second end 63 and has a grip 122 configured for finger manipulation. An opposite end of rotation pin 67 extends from an opposite side of second end 63 and is affixed to one end of a rotation lever 126. An opposite end of rotation lever 126 has an opening to receive an end of the cross bar 124 opposite from the extension portion 66 of extension arm 64. Collectively, a portion of first end 63, rotation lever 67, extension arm 64 and cross bar 51 establish the opening 124. In one exemplary embodiment of first swivel connecting device 50, opening 124 of second interlocking mechanism 70 has a greater width than the width of opening 125 for first interlocking mechanism 72.

It should be understood that for other exemplary embodiments of inventive swivel connecting devices, the swivel connecting devices can include opening 124 of second interlocking mechanism 70 as having dimensions that are smaller than the dimensions of opening 125 for first interlocking mechanism 72. Still further, it should be understood that for other exemplary embodiments of inventive swivel connecting devices, the swivel connecting devices can include opening 124 of second interlocking mechanism 70 as having the same dimensions as the dimensions of opening 125 for first interlocking mechanism 72.

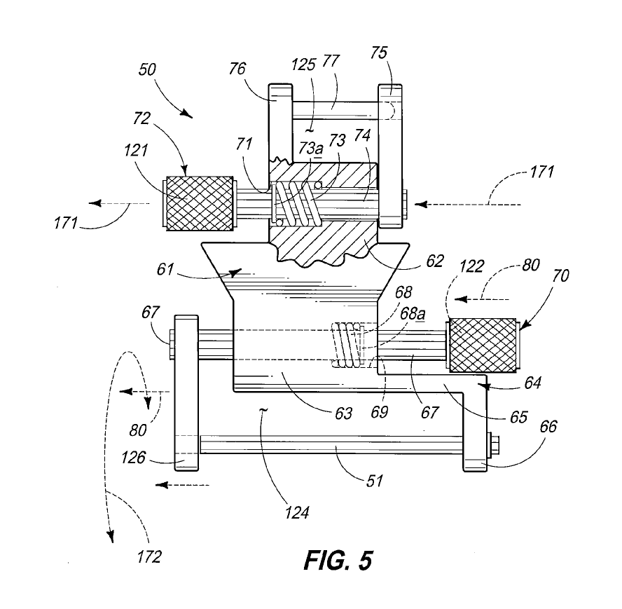

Referring to FIGS. 4 and 5, structure inside the first swivel connecting device 50 is illustrated according to one of various embodiments of the invention. Exemplary first and second ends 62 and 63 of main body 61 are partially broken away to expose respective rotation pins 74 and 67 of first and second interlocking mechanisms 72 and 70 extending through respective openings. Exemplary swivel connecting device 50 includes first interlocking mechanism 72 having biasing members 68 and 73 received over and in biasing relation to each rotation pin 67 and 74, respectively. Exemplary biasing members 68 and 73 are springs retained over respective rotation pins 67 and 74. Biasing members 68 and 73 are held in the biasing relationship by retaining collars or rings (or pins not shown) 68a and 73a, respectively, affixed to the rotation pins 67 and 74 adjacent or against springs 68 and 73. The openings which receive rotation pins 67 and 74 in first and second ends 62 and 63 have enlarged portions 69 and 71, respectively, to accommodate receipt of springs 68 and 73.

Again referring to FIG. 4, rotation pin 74 is shown capable of being forced in an axial direction 78 along the longitudinal axis of rotation pin 74 against the biasing influence of spring 73. By a first exemplary method step, manipulation of grip 121 (for example, with a finger), rotation pin 74 can be moved along the longitudinal axis in direction 78 until grip 121 contacts or is adjacent the side of the first end 62 of main body 61. In response to this first method step which includes movement of rotation pin 74, rotation lever 75 is additionally moved off the end of cross bar 77. While a force is maintained to counteract and oppose the biasing force of spring 73, a second exemplary method step includes manipulation of grip 121 with the finger to rotate rotation pin 74 about or around the longitudinal axis in a rotation direction 79. This second method step will also rotate rotation lever 75 about or around the longitudinal axis in the rotation direction 79 to expose the end of cross bar 77 and facilitate access to cross bar 77. Access to cross bar 77 provides for the capability of performing a third exemplary method step that includes providing cross bar 77 to be received in or through another structure, such as a swivel mount secured on a firearm, shown and explained subsequently.

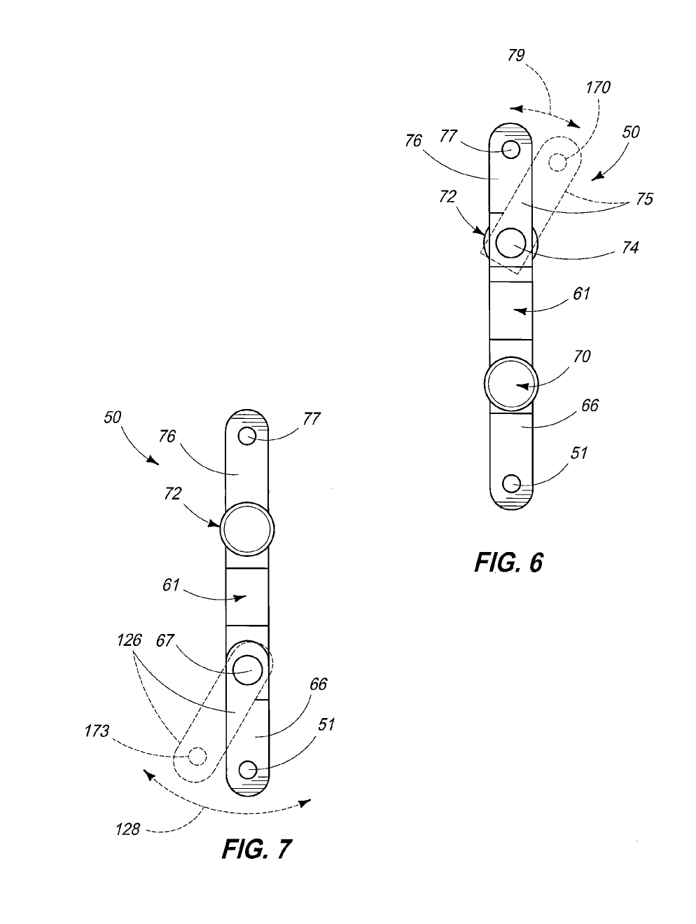

Referring to FIG. 6, it should be understood that rotation lever 75 can be rotated, considering the context of this view, to the right or to the left in either direction of rotation direction 79.

Still referring to FIGS. 5 and 6, after performing the third method step which includes cross pin 77 being received on the another structure, a fourth exemplary method step includes rotating rotation lever 75 along rotation direction 79 to align opening 170 of rotation lever 75 with the end of cross pin 77. An exemplary fifth method step includes relaxing the force being applied by finger manipulation to counteract the biasing influence of spring 73 to allow spring 73 to begin to bias rotation pin 74 in axial direction 171 which is opposite to axial direction 78. As rotation pin 74 moves in direction 171, the rotation lever 75 also moves in axial direction 171 until opening 170 of rotation lever 75 is moved upon the end of cross pin 77. In this configuration, opening 125 is again collectively formed by the portion of first end 62, rotation lever 75, extension arm 76 and cross bar 77 wherein the another structure is at least partially resting in opening 125 with first interlocking mechanism 72 securing the first swivel connecting device 50 to the another structure such as the firearm swivel mount.

Referring to FIGS. 4, 5 and 7, the exemplary swivel connecting device 50 includes second interlocking mechanism 70 to operate and function similarly as first interlocking mechanism 72. As stated previously, second interlocking mechanism 70 has biasing member (spring) 73 received over and in biasing relation to rotation pin 67. Biasing member 68 is held in the biasing relationship by retaining collar or ring (or pin) 68a affixed to the rotation pin 67 adjacent or against spring 68. The openings which receive rotation pin 67 in second end 63 has enlarged portion 69 to accommodate receipt of spring 68.

Still referring to FIGS. 4, 5 and 7, rotation pin 67 can be forced in an axial direction 80 along the longitudinal axis of rotation pin 67 against the biasing influence of spring 68. By a first manipulation of grip 122 (exemplary first method step) with a finger, rotation pin 67 can be moved along the longitudinal axis in direction 80 with grip 122 moving adjacent the side of the second end 63 of main body 61. In response to this movement of rotation pin 67, rotation lever 126 is moved off the end of cross bar 51. While a force is maintained to counteract the biasing force of spring 68, a second manipulation of grip 122 (exemplary second method step) can be performed to rotate rotation pin 67 about or around the longitudinal axis in a rotation direction 172. This second manipulation action will also rotate rotation lever 126 about or around the longitudinal axis in the rotation direction 172.

Referring to FIG. 7, it should be understood that rotation lever 126 can be rotated, considering the context of this view, to the right or to the left in either direction of rotation direction 172. Further by this second manipulation action, rotation lever 126 is moved away from cross bar 51 to expose the end of cross bar 51 and facilitate access to cross bar 51. Access to cross bar 51 provides for cross bar 51 to be received in or through another structure (exemplary third method step), again such as a swivel mount secured on a firearm (shown and explained subsequently).

Still referring to FIGS. 4, 5 and 7, after cross pin 51 is received on the another structure (after third method step), rotation lever 126 is rotated along direction 172 (exemplary fourth method step) to align opening 173 of rotation lever 126 with the end of cross pin 51. Next, the force applied by finger manipulation to counteract the biasing influence of spring 68 is relaxed (exemplary fifth method step) to allow spring 68 to begin to bias rotation pin 67 in an axial direction which is opposite to axial direction 80 (opposite axial direction is not shown). As rotation pin 67 moves in this opposite direction to axial direction 80, the rotation lever 126 also moves in this opposite direction to axial direction 80 until opening 173 of rotation lever 126 is moved upon the end of cross pin 126. In this configuration, opening 124 is again collectively formed by the portion of second end 63, rotation lever 126, extension arm 64 and cross bar 51 wherein the another structure is at least partially resting in opening 124 of second interlocking mechanism 70.

Referring to FIG. 8, another exemplary body securement apparatus 84 is illustrated secured to an exemplary firearm 85 according to one of various embodiments of the invention. Structures and configurations of firearm securement device 85 that have been described previously are referenced with the same reference number as previously used. The exemplary firearm 85 is a rifle such as a hunting rifle having barrel 86 with a scope 87 and secured in a stock assembly 83 that includes the forestock 91 or forearm and stock 86 with butt. The exemplary firearm 85 has a first swivel mount 89 and a second swivel mount 90. The exemplary body securement apparatus 84 includes second strap 102 having second swivel connecting device 52 releasably securing second strap 102 to second mount 90. The exemplary body securement apparatus 84 further includes first strap 112 connected to second strap 102 and having first swivel connecting device 50 releasably securing first strap 112 to first mount 89. This exemplary embodiment of body securement apparatus 84 includes the first strap 112 having a buckle 114 and terminating to form a loop 113 to be received over cross bar 51 of second interlocking mechanism 70 for swivel connecting device 50.

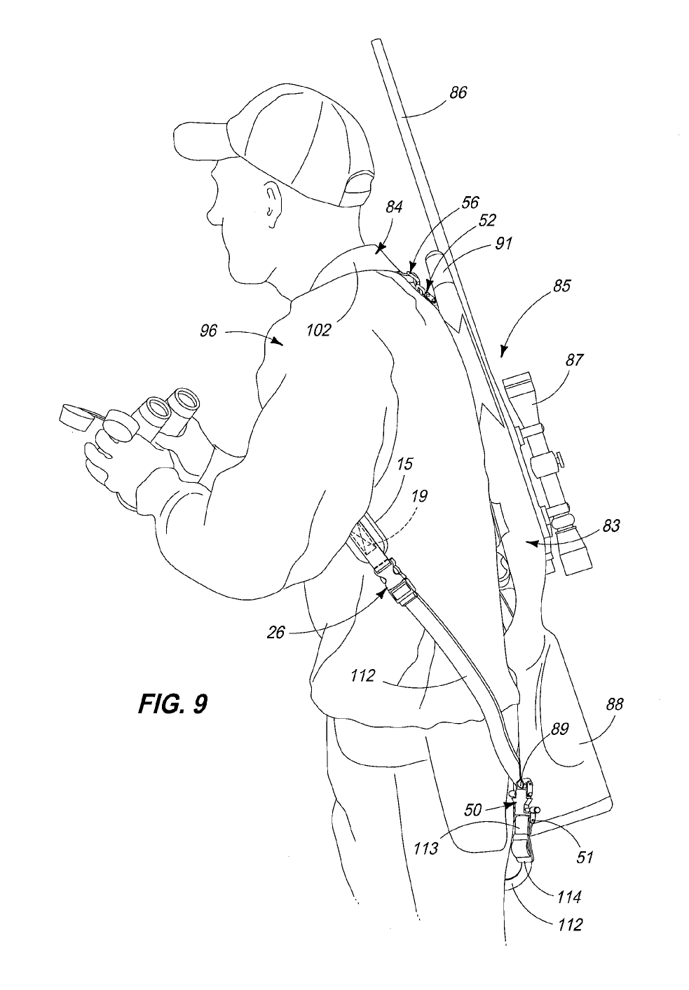

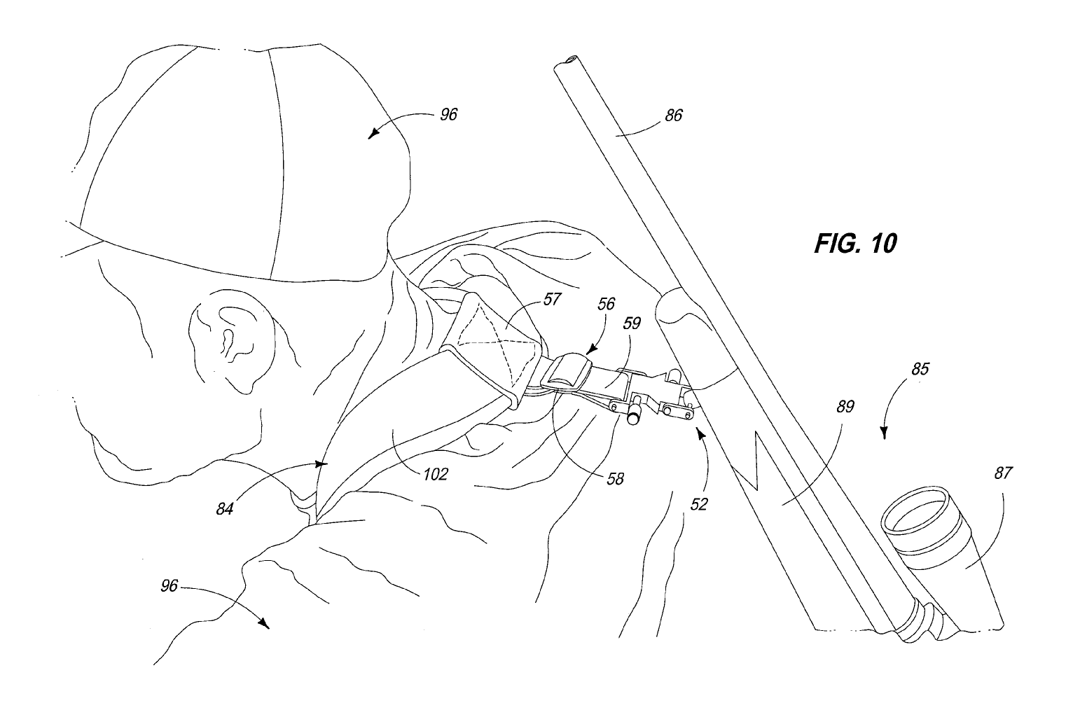

Referring to FIGS. 9 and 10, the exemplary body securement apparatus 84 of FIG. 8 secured to firearm 85 is illustrated provided upon an individual 96, such as a hunter, according to one of various embodiments of the invention. In this exemplary method of using of body securement apparatus 84, the barrel 86 of firearm 85 is directly upright behind the back of the head of hunter 96. In this position, the flexible material of second strap 102 establishes an apex generally at the patch 57 of second strap 102 which is generally position at the nape of the neck of the hunter 96. The adjustable strip 56 and second swivel connecting device 52 extend down from the nape of the neck along the back of the hunter 96 to the firearm 85. The second strap 102 of the body securement apparatus 84 extends around the back portion of the neck, over the shoulders and under the arms of hunter 96 to continue angled toward the lower back. First strap 112 of body securement apparatus 84 continues down the lower back to secure the stock 88 with the butt resting adjacent or against the lower back and buttocks of the hunter 96.

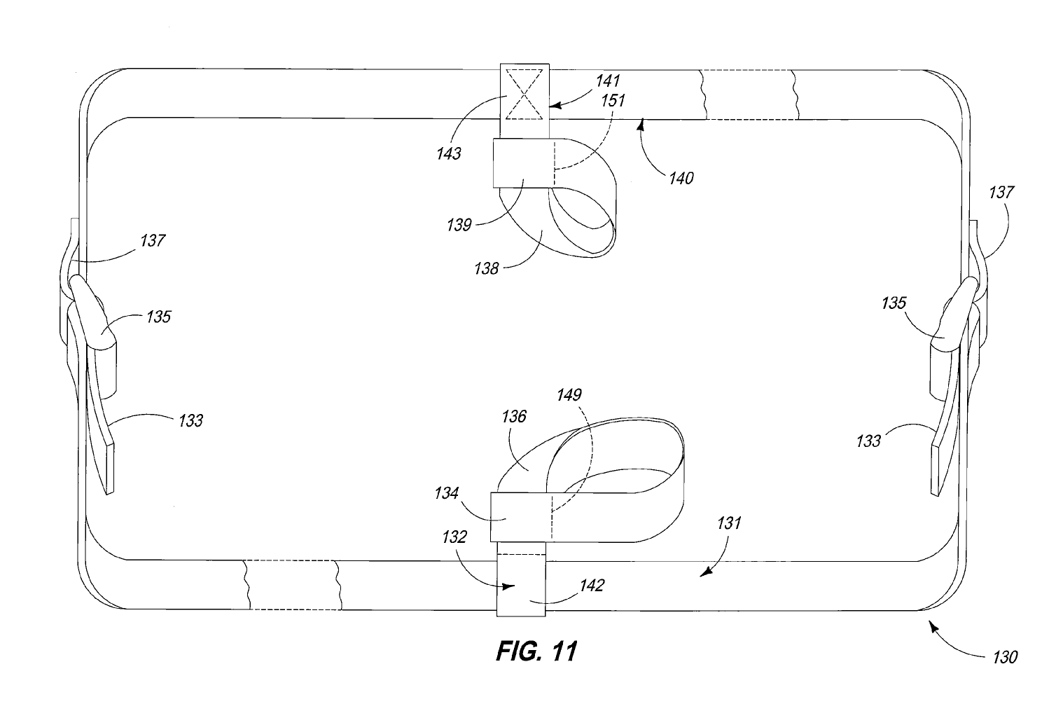

Referring to FIG. 11, another exemplary body securement apparatus 130 is illustrated according to another of various embodiments of the invention. Structures and configurations of body securement apparatus 130 that have been described previously are referenced with the same reference number as previously used. An exemplary body securement apparatus 130 includes a first strap 131 buckled to a second strap 140. First strap 131 has opposite ends 133 threaded through portions of respective buckles 135 in a configuration to provide length adjustment capabilities for first strap 131. Second strap 140 has opposite ends 137 formed as loops which are received on portions of respective buckles 135 in a more stationary and permanent configuration lacking length adjustment capabilities for second strap 140.

Still referring to FIG. 11, first strap 131 includes an adjusting loop 132. An exemplary adjusting loop 132 is flexible material having a first sliding portion 134 received upon the flexible material to form loop section 136. An exemplary first sliding portion 134 is configured to slide over portions of the flexible material to provide the capability to selectively diminish, and alternatively selectively increase, the size of loop section 136. The first sliding portion 134 is a loop of the flexible material enclosed with stitching 149 and formed around another portion of the flexible material of adjusting loop 132. Additionally, adjusting loop 132 includes a second sliding portion 142 that is slidingly received upon first strap 131 to provide sliding capabilities for adjusting loop 132 along an entire length of the first strap 131. An exemplary second sliding portion 142 is a loop of the flexible material enclosed with stitching 149 and formed around another portion of the flexible material of adjusting loop 132.

Still referring to FIG. 11, second strap 140 includes an adjusting loop 141. An exemplary adjusting loop 141 is flexible material having a sliding portion 139 received upon the flexible material to form loop section 138. An exemplary sliding portion 139 is configured to slide over portions of the flexible material to provide the capability to selectively diminish, and alternatively selectively increase, the size of loop section 138. The sliding portion 139 is a loop of the flexible material enclosed with stitching 151 and formed around another portion of the flexible material of adjusting loop 141. Additionally, adjusting loop 141 includes an attachment portion 143 that affixes adjusting loop 141 to second strap 140.

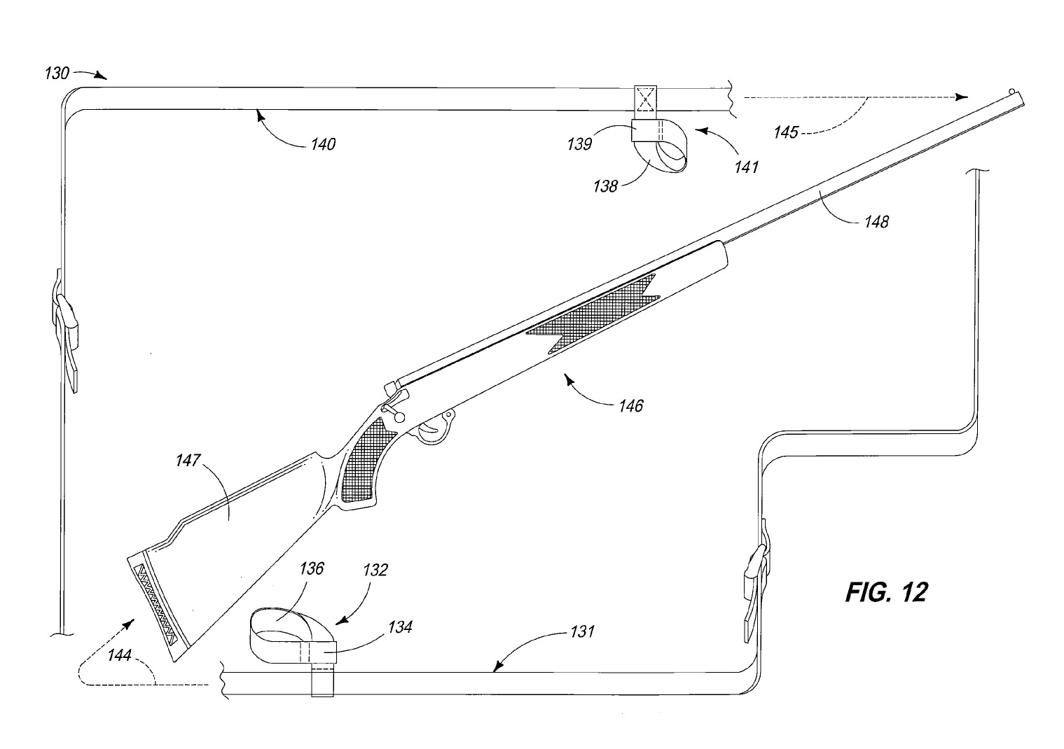

Referring to FIG. 12, an exemplary method of securing body securement apparatus 130 to a firearm 146 is illustrated according to one of various embodiments of the invention. Structures and configurations that have been described previously are referenced with the same reference number as previously used. An exemplary method includes moving adjusting loop 141 along direction 145 to be received over a barrel 148 of firearm 146. It should be understood that since adjusting loop 141 is affixed to second strap 140, the entire second strap 140 moves along direction 145 (and the entire first strip 131 if releasably secured to second strip 140 via respective buckles 135). Sliding portion 139 is moved along the flexible material of adjusting loop 141 to selectively diminish (or decrease) the size of loop section 138 thereby tightening the adjusting loop 141 around barrel 148. The exemplary method further includes moving adjusting loop 132 along direction 144 to be received over a shoulder stock 147 of firearm 146. It should be understood that since adjusting loop 132 slidingly engages first strap 131, only adjusting loop 132 has to move along direction 144 which allows for size adjustment of body securement apparatus 130 to accommodate differently-sized (or length) firearms. Sliding portion 134 is moved along the flexible material of adjusting loop 132 to selectively diminish (or decrease) the size of loop section 136 thereby tightening the adjusting loop 132 around shoulder stock 147.

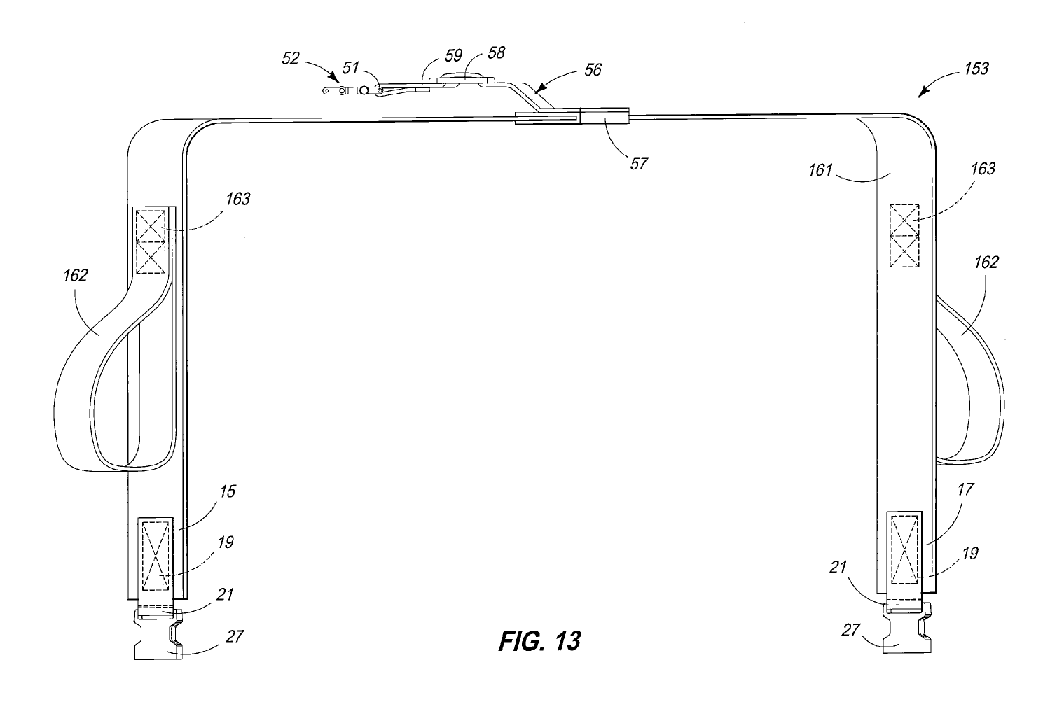

Referring to FIG. 13, another embodiment for a body securement apparatus 153 is illustrated according to one of various embodiments of the invention and showing only an exemplary second strap 161 of the device 153. Structures and configurations that have been described previously are referenced with the same reference number as previously used. An exemplary second strap 161 includes a pair of carrying loops 162 stitched 163 to the flexible material of second strap 161. One exemplary carrying loop 162 is secured between one of the female elements 27 and patch 57, and the other carrying loop 162 is secured between the other of the female elements 27 and patch 57.

It should be understood that carrying loops 162 will rest in front of a chest or belly of an individual when the body securement apparatus 153 is provide upon an individual as shown in FIG. 9. One exemplary method of use for carrying loops 162 is a to place respective ends of another structure in the carrying loops 162 wherein the another structure would be positioned across the chest of an individual. An exemplary another structure includes a second firearm to be supported upon the body securement apparatus 153. Alternatively, the arms of an individual can be provided through respective carrying loops 162 to increase the level of securement of the firearm to the body of an individual. That is, the looseness of the firearm next to the body (movement of the firearm relative the body) would be diminished which can be beneficial to the individual during activity such as running to minimize the movement of the firearm to prevent injury to the body and the latching onto brush.

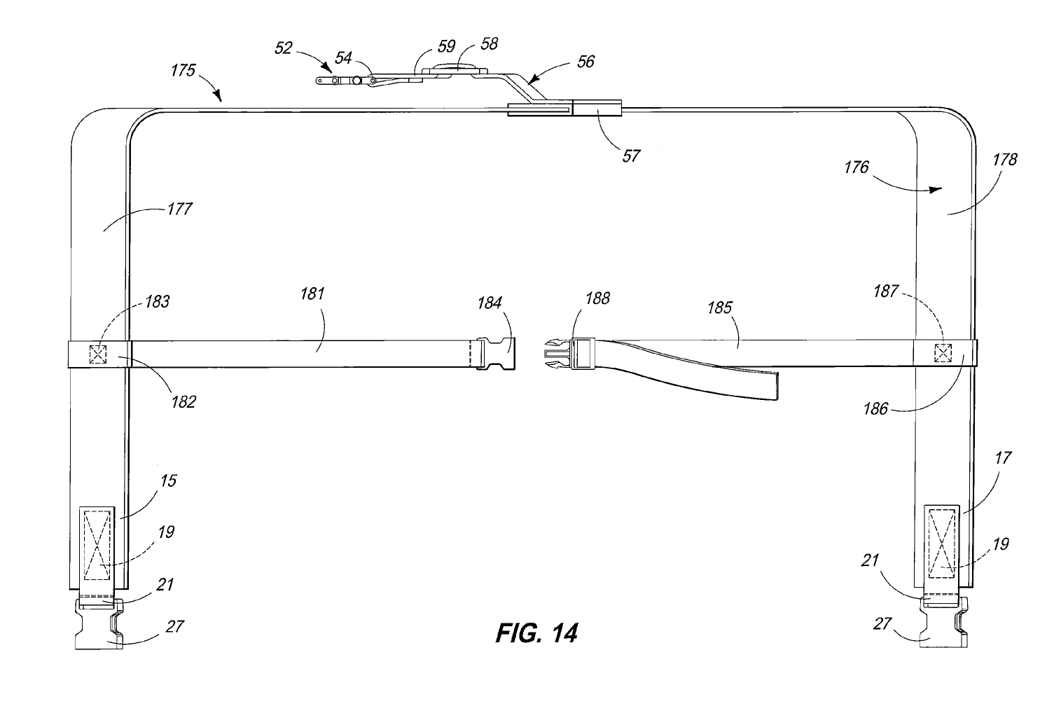

Referring to FIG. 14, another embodiment for a body securement apparatus 175 is illustrated according to one of various embodiments of the invention and showing only an exemplary second strap 176 of the device 175. Structures and configurations that have been described previously are referenced with the same reference number as previously used. An exemplary second strap 176 includes a pair of adjustment extensions 181 and 185. Adjustment extension 181 includes a stitch portion 182 that stitches 183 adjustment extension 181 to a first portion 177 of flexible material of device 175 between female member 27 and adjustment strip 56. An end of adjustment extension 181 opposite the stitch portion 182 is secured to a female element 184.

An exemplary adjustment extension 185 includes a stitch portion 186 that stitches 187 adjustment extension 185 to a second portion 178 of flexible material of device 175 between female member 27 and adjustment strip 56. An end of adjustment extension 185 opposite the stitch portion 186 is sliding engaged to a male element 188 to provide length adjustment capabilities of adjustment extension 185. Male element 188 is configured to be selectively locked and unlocked with female element 184. In this configuration with the male element 188 locked with the female element 184, the looseness of the firearm next to the body (movement of the firearm relative the body) would be diminished which is beneficial to the individual during activity such as running to minimize the movement of the firearm to prevent injury to the body and the latching or catching of the firearm onto brush and bushes.

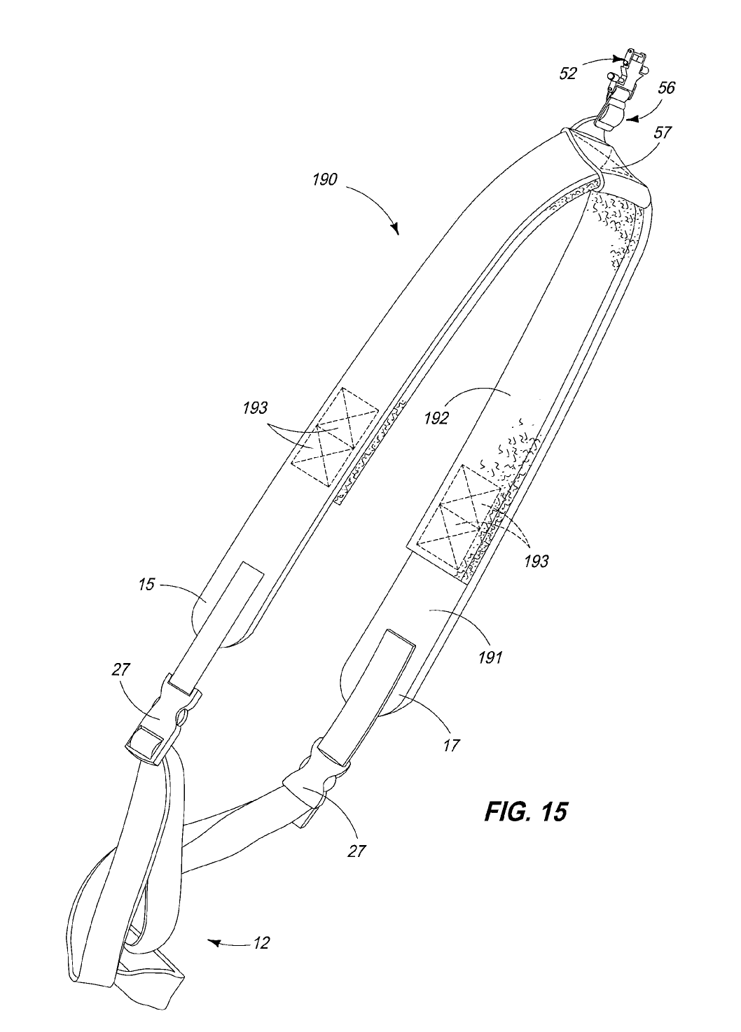

Referring to FIG. 15, another embodiment for a body securement apparatus 190 is illustrated according to one of various embodiments of the invention. Structures and configurations that have been described previously are referenced with the same reference number as previously used. An exemplary second strap 191 includes a layer of material 192 stitched with stitching 193 to the flexible material of second strap 191. The various exemplary materials for the layer of material 192 include various nylon materials, various thermoplastic polyamides capable of extrusion into or onto fibers and sheets, various cloth or threaded materials, various rubber materials, neoprene, polychloroprene and/or leather. One exemplary purpose for the layer of material 192 is to further cushion the weight (in addition to the cushion capabilities of the second strap without the layer of material 192) of the body securement apparatus 190 (and any structure secured to device 190) on the neck and shoulders of an individual. The use of body securement apparatus 190 can diminish fatigue for the individual when using the body securement apparatus 190.

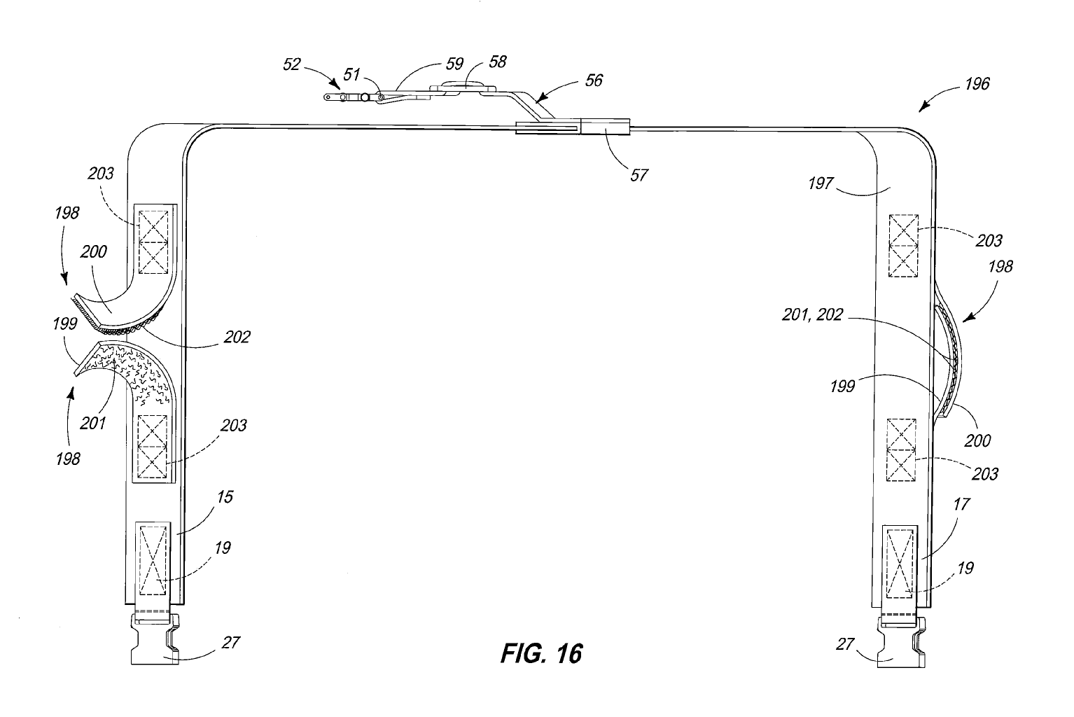

Referring to FIG. 16, another embodiment for an attachment apparatus 196 is illustrated according to one of various embodiments of the invention. Structures and configurations that have been described previously are referenced with the same reference number as previously used. An exemplary second strap 197 includes a pair of fastener devices 198. Each fastener device 198 has a first flap 199 and a second flap 200. Moreover, each first flap 199 has an attachment material 201 provided on an upper surface of each first flap 199. An exemplary material for attachment material 201 is Velcro®. However, other exemplary materials that exhibit attachment or securement qualities could be used for attachment material 201. Furthermore, each second flap 200 has an attachment material 202 provided on lower surface of second flap 200. An exemplary material for attachment material 202 is Velcro®. However, other exemplary materials that exhibit attachment or securement qualities could be used for attachment material 202. Each first flap 199 and each second flap 200 are stitched with stitching 203 to the flexible material of second strap 197.

Still referring to FIG. 16, it should be understood that with this configuration of first and second flaps 199 and 200, respective fastener devices 198 can be provided in an “opened” configuration as shown for the “left” fastener device 198 in context of this view of FIG. 16. In this “opened” configuration for fastener device 198, first flap 199 is not attached to second flap 200 and each respective flap can be moved away from the other opposing flap. Still further, respective fastener devices 198 can be provided in a “closed” configuration as shown for the “right” fastener device 198 in context of this view of FIG. 16. In this “closed” configuration for fastener device 198, the second flap 200 is provided over and against the first flap 199 having the attachment material 201 of the first flap 199 engage or interact with the attachment material 202 of the second flap 200 thereby securing or attaching the first flap 199 to the second flap 200.

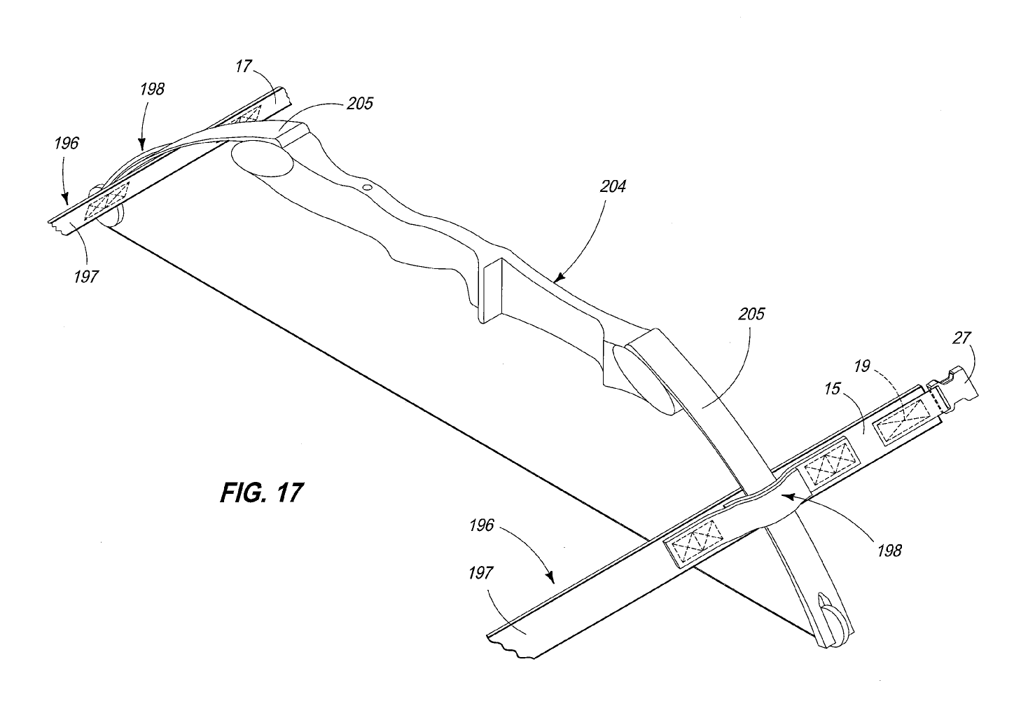

Referring to FIG. 17, an exemplary method for using the attachment apparatus 196 of FIG. 16 is illustrated according to one of various embodiments of the invention. Structures and configurations that have been described previously are referenced with the same reference number as previously used. At least one fastener device 198 is provided in a “closed” configuration over a limb 205 of an archery bow 204. It should be understood that other structures can be held or secured to attachment apparatus 196, for example, firearms such as rifles.

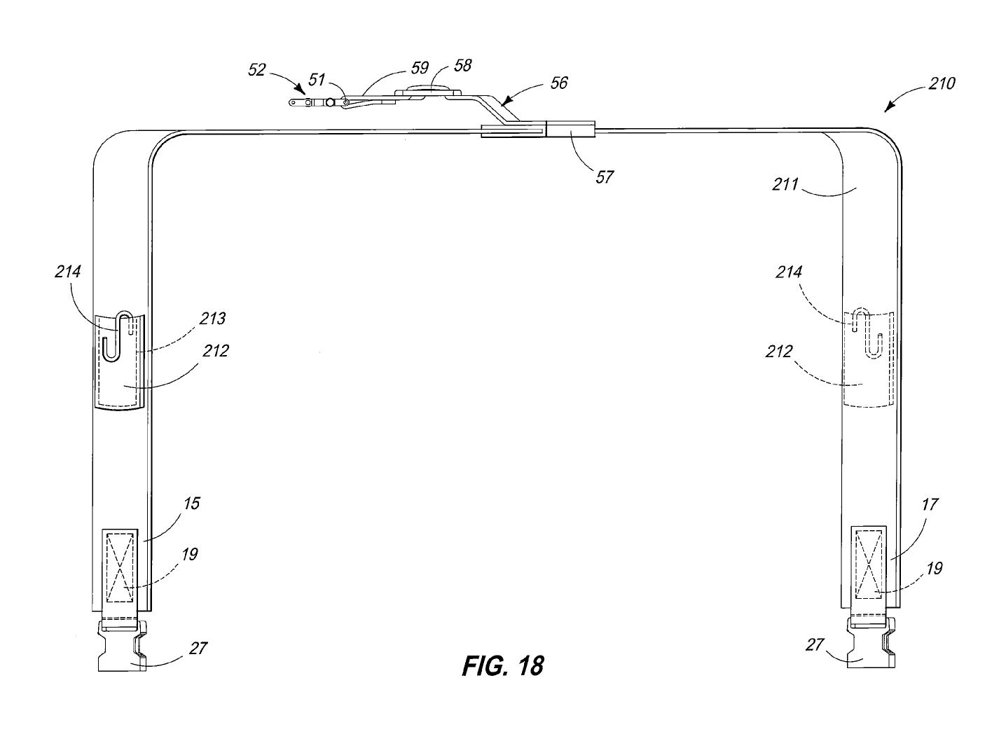

Referring to FIG. 18, another embodiment for an attachment apparatus 210 is illustrated according to one of various embodiments of the invention. Structures and configurations that have been described previously are referenced with the same reference number as previously used. An exemplary second strap 211 includes at least one pocket 212 stitched with stitching 213 to second strap 211. In this exemplary embodiment, a pair of pockets 212 is stitched with stitching 213 to second strap 211. Exemplary methods of use for attachment apparatus 210 according to various embodiments of the invention is to provide items in the pockets 212, for example, cartridges for firearms, snacks and food, and devices to facilitate a hunting trip. Additionally, pockets 212 can be used to receive devices and/or apparatuses that have hooks wherein a curved portion of the hooks on the devices and/or apparatuses is positioned to rest in the pockets 212.

Still referring to FIG. 18, another embodiment for an attachment apparatus 210 is illustrated according to one of various embodiments of the invention and includes providing at least one hook device 214 in at least one pocket 212. An exemplary hook device 214 is a double-curve configuration. Accordingly, one curve of hook device 214 can be positioned (or rested) or supported in pocket 212 while the second curve of hook device 214 is exposed outside the pocket 212 to receive another structure wherein the another structure is hung or supported onto the second curve of hook device 214. In this exemplary embodiment, a pair of hook device 214 is provided with a single hook device 214 for each pocket 212. It should be understood that any one of the hook devices 214 is optional wherein attachment apparatus 210 can include no hook devices 214 or as many as respective pockets 212 can hold and support. Moreover, It should be understood that more than one hook device 214 can be provided or supported upon each one pocket 212.

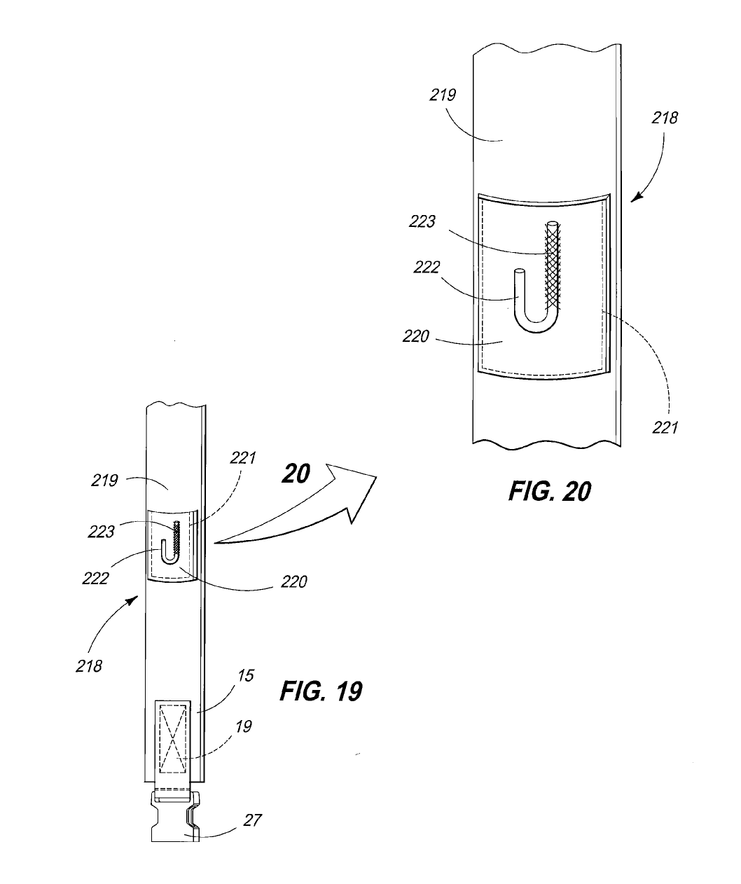

Referring to FIGS. 19 and 20, another embodiment for an exemplary attachment apparatus 218 is illustrated according to one of various embodiments of the invention. Structures and configurations that have been described previously are referenced with the same reference number as previously used. An exemplary second strap 219 includes at least one pocket 220 stitched with stitching 221 to second strap 219. An exemplary at least one pocket 220 includes a hook device 222 secured to pocket 220 with stitching 223. It should be understood that other exemplary embodiments of attachment apparatus 218 include having no pockets wherein hook device 222 is secured directly to second strap 219.

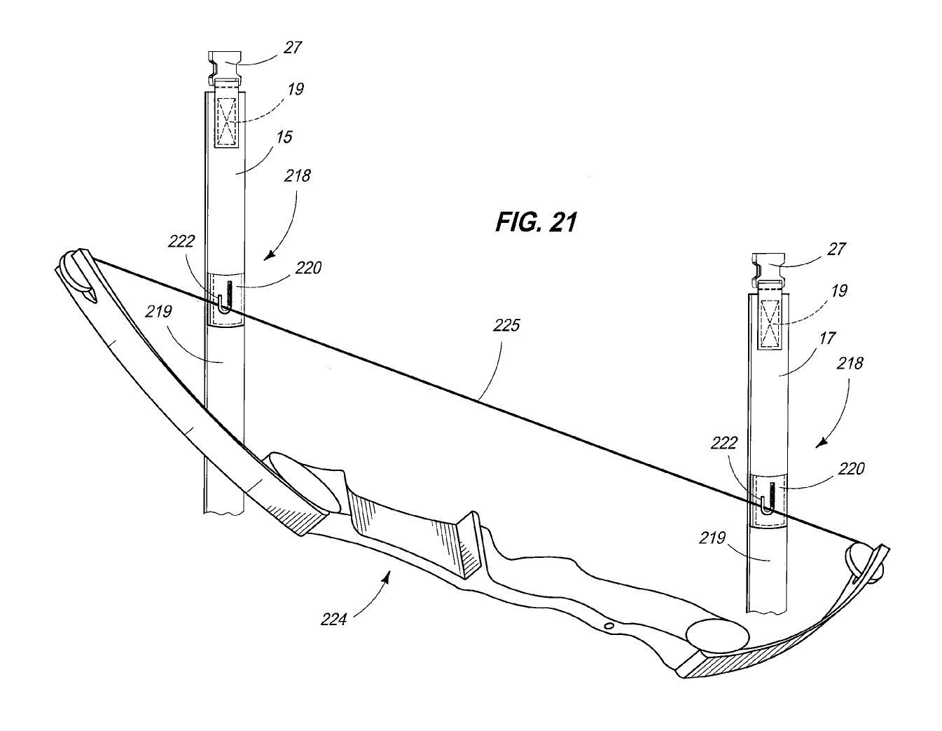

Referring to FIG. 21, exemplary methods of use for attachment apparatus 218 is illustrated according to one of various embodiments of the invention. A pair of hook devices 222 is secured to second strap 219 to receive, as only one example, a bow string 225 of an exemplary archery bow 224. It should be understood that other structures and items can be provided on hook devices 222.

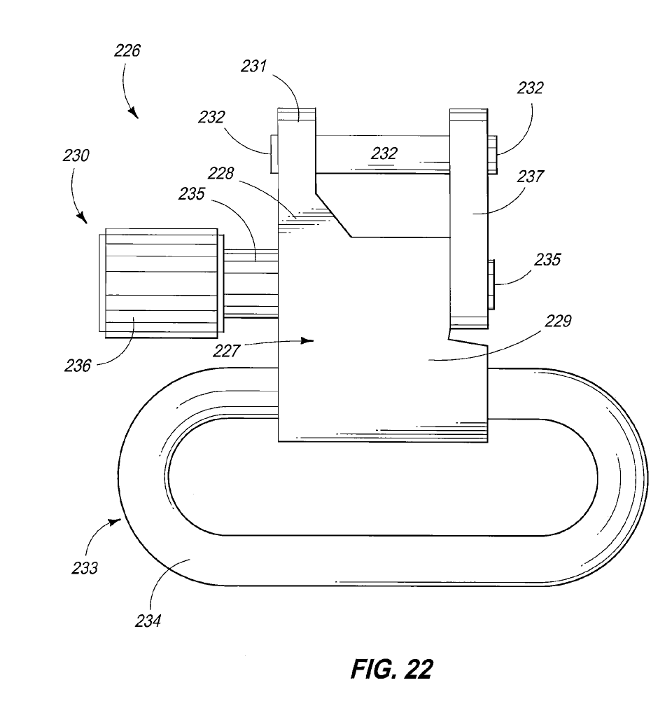

Referring to FIG. 22, another embodiment for an exemplary swivel connecting device (connector or connecting device) 226 is illustrated according to one of various embodiments of the invention. It should be understood that swivel connecting device 226 can be one of a first, second, third and one of up to at least twenty swivel connecting devices for any exemplary body securement device or attachment apparatus to secure a structure, such as a firearm or hunting apparatus, to a body. An exemplary swivel connecting device 226 includes a main body 227 having an exemplary composition of plastic, metal, metal alloy, thermoplastic and/or combination of any composition listed. Main body 227 has a first end 228 opposite a second end 229. First end 228 has a first interlocking mechanism 230. First end 228 further includes an extension arm 231 having a linear shape and extending integrally outwardly (upwardly in this view) from the first end 228 of main body 227. One end of a cross bar 232 is affixed to, and extends perpendicularly from, one side of extension arm 231.

Still referring to FIG. 22, an exemplary embodiment for first interlocking mechanism 230 includes a rotation pin 235 extending longitudinally through an opening in first end 228 of the main body 227 of the first swivel connection device 230. One end of rotation pin 235 extends from one side of first end 228 and has a grip 236 configured for finger manipulation. An opposite end of rotation pin 235 extends from an opposite side of first end 228 and is affixed to one end of a rotation lever 237. An opposite end of rotation lever 237 has an opening to receive an end of cross bar 232 opposite from the extension arm 231. Collectively, a portion of first end 228, rotation lever 237, extension arm 231 and cross bar 232 establish an opening to receive a portion of a swivel mount and over cross bar 232 as previously discussed relative exemplary swivel mounts. Alternatively, loops established in the ends of either one or both of exemplary first and second straps of attachment apparatuses could be received over cross bar 232 of first interlocking mechanism 230.

Still referring to FIG. 22, the exemplary swivel connecting device 226 includes a second interlocking mechanism 233 in the second end 229 of main body 227. An exemplary second interlocking mechanism 233 includes a ring structure 234 having an oblong circular configuration with two opposite ends residing in the second end 229 of the main body 227.

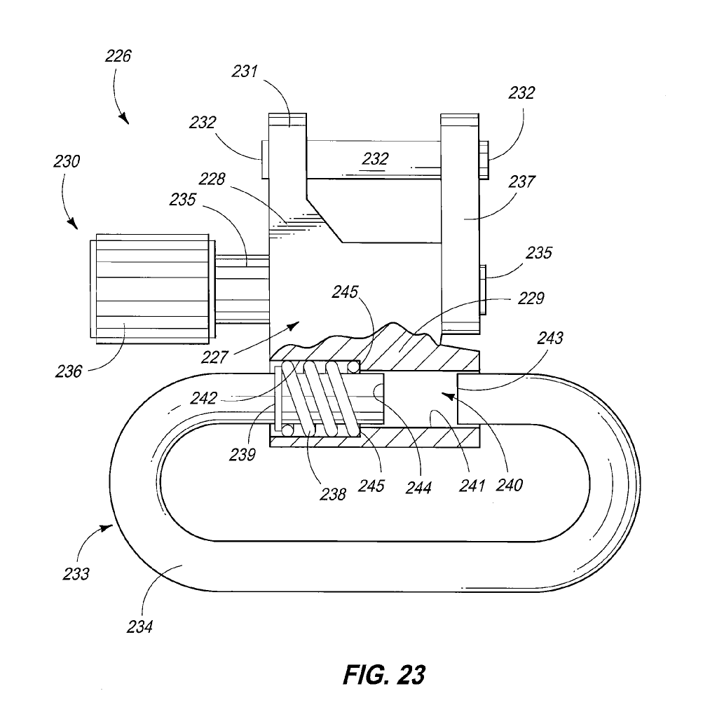

Referring to FIG. 23, structure inside the swivel connecting device 226 is illustrated according to one of various embodiments of the invention. A fragmented front surface portion of the main body 227, particularly the second end 229, is removed to expose a first terminus 243 opposite a second terminus 244 of ring structure 234. The first terminus 243 is spaced from the second terminus 244 wherein the ring structure 234 is not a continuous, uninterrupted structure. The position and state of the ring structure 234 illustrated can be termed the “relaxed position” (or “closed” position or “locked” position) which is defined as the ring structure 234 having no external force being applied to the ring structure 234. First and second terminuses 243 and 244 reside in an opening 240 configured as a bore that extends laterally across an entire width of the second end 229 of the main body 227. The exemplary opening 240 has a first portion 241 with a first diameter configured to receive the first terminus 243 of ring structure 234. Opening 240 has a second portion 242 extending from and along the same axis as the first portion 241 with the second portion 242 having a second diameter that is greater than the first diameter of the first portion 241.

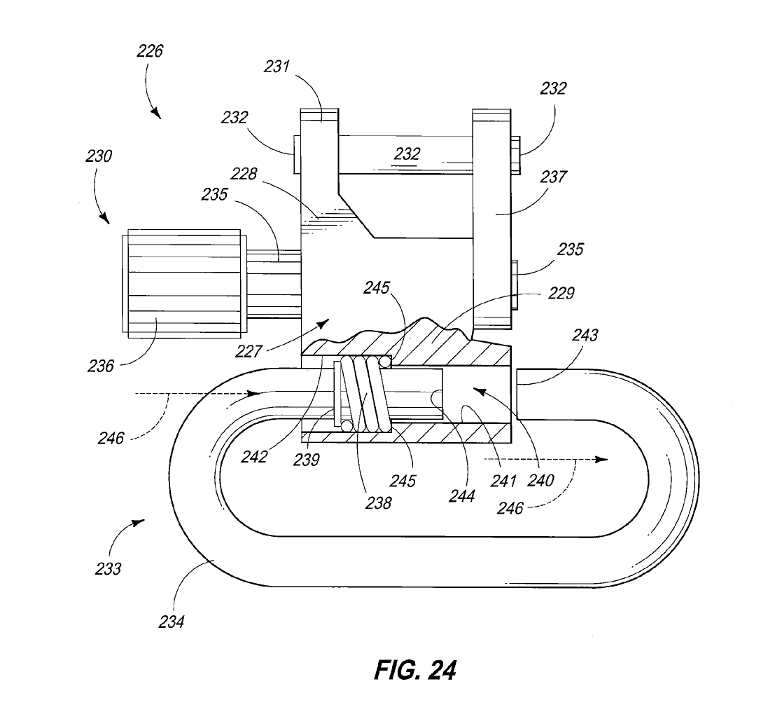

Still referring to FIG. 23, the second interlocking mechanism 233 includes a biasing member 238 received in the second portion 242 of opening 240. An exemplary biasing member 238 is a spring wherein the second diameter of the second portion 242 accommodates an outer diameter of spring 238. The exemplary spring 238 is received over the second terminus 244 of ring structure 234 and has one end resting against or abutting a retaining collar 239 which is affixed to the ring structure 234. An opposite end of the spring 238 (opposite the end against the retaining collar 239) rests against or abuts a shoulder 245 of opening 240 where the first portion 241 intersects the second portion 242. In this position, the spring 238 provides a biasing action on the retaining collar 239 which effectively provides a biasing action on the ring structure 234 to the left (opposite direction 246 of FIG. 24) in this view.

Referring to FIG. 24, and by a first exemplary method step, manipulation of ring structure 234 (for example, with a finger not shown) is implemented by applying a force on ring structure 234 in an axial direction 246 and moves ring structure 234 in axial direction 246. During this first method step, retaining collar 239 moves in the axial direction 246 against spring 238 further into opening 240 to compress spring 238 toward shoulder 245. Moreover, since the first terminus 243 is spaced from the second terminus 244, the first terminus 243 of ring structure 234 moves in direction 246. If ring structure 234 moves a great enough distance, it will exit the first portion 241 of opening 240. In this position, the ring structure 234 and the second interlocking mechanism 233 of swivel connecting device 226 can be termed as being in the “opened” or “unlocked” position.

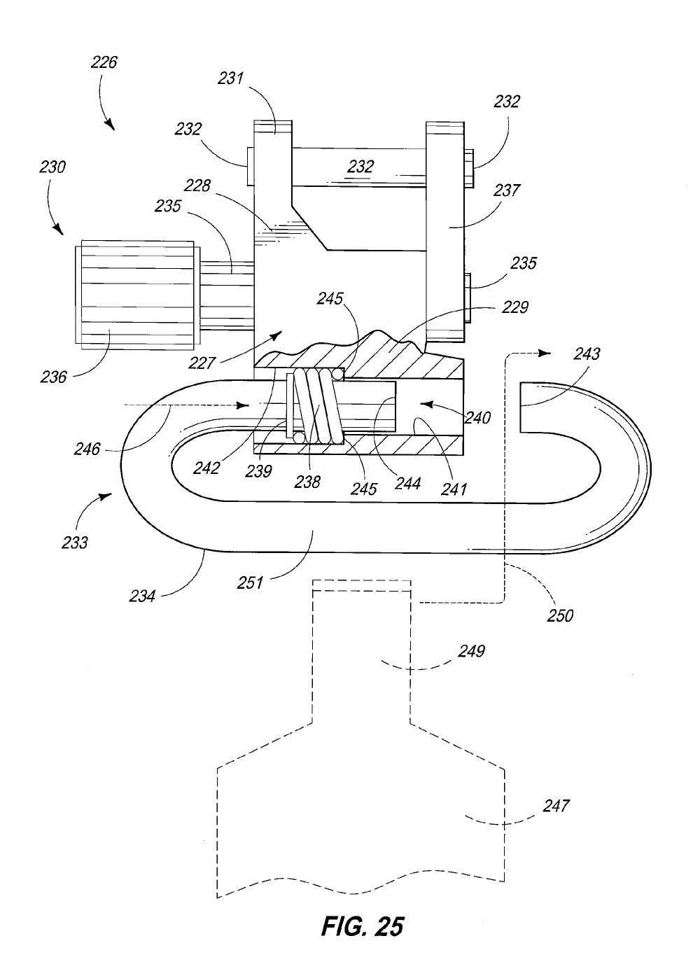

Referring to FIG. 25, and while maintaining the “opened position” by continuing to apply the force on ring structure 234 to counteract or oppose the biasing force of spring 238, a space is maintained between the first terminus 243 of ring structure 234 and the second end 229 of main body 227. As an exemplary second method step, flexible material of an exemplary strap 247 for any exemplary body securement apparatus described previously can be provided having a loop 249 at the end of strap 247. Loop 249 can be moved along direction 250 to be positioned to slip over first terminus 243 of ring structure 234. In an exemplary third method step, loop 249 is continually moved in a sliding fashion over the ring structure 234 ultimately to rest on the lower section 251 (in this view) of ring structure 234. Accordingly, with this third method step, strap 247 of the any exemplary body securement apparatus is provided onto the second interlocking mechanism 233 of swivel connecting device 226.

Still referring to FIG. 25, as an exemplary fourth method step, the biasing force applied in the direction 246 is withdrawn to allow the biasing force of spring 238 acting on retaining collar 239 to move ring structure 234 in the direction opposite to direction 246. During the movement of ring structure 234 in the direction opposite to direction 246, first terminus 243 of ring structure 234 reenters the first portion 241 of opening 240. In this fourth method step, the ring structure 234 and the second interlocking mechanism 233 of swivel connecting device 226 are returned to the “closed” or “locked” position. Accordingly, in the closed position, strap 247 of the any exemplary body securement apparatus is secured and locked onto the swivel connecting device 226. It should be understood that the first interlocking mechanism 230 of swivel connecting device 226 operates and functions the same as described previously for first interlocking mechanism 72 of the first swivel connecting device 50.

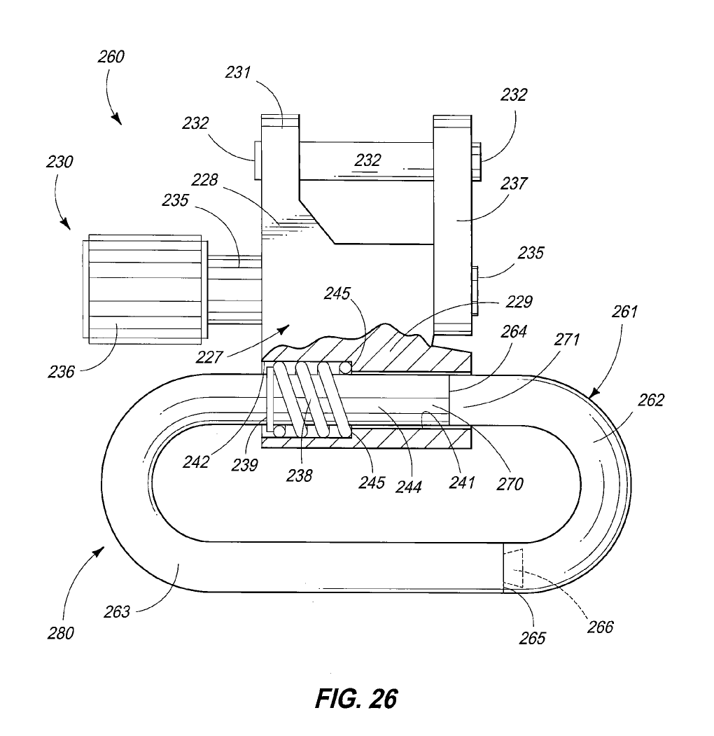

Referring to FIG. 26, another embodiment for an exemplary swivel connecting device 260 is illustrated according to one of various embodiments of the invention. Structures and configurations of exemplary swivel connecting devices that have been described previously are referenced with the same reference number as previously used. It should be understood that swivel connecting device 260 can be one of a first, one of a second, one of a third and one of up to at least twenty swivel connecting devices for any exemplary body securement apparatus or body attachment apparatus to secure a structure, such as a hunting apparatus, to an individual's body. An exemplary swivel connecting device 260 includes a second interlocking mechanism 280 that includes a ring structure 261. It should be understood that the illustrated position of the second interlocking mechanism 280 in FIG. 26 can termed the “closed” or “locked” (or “relaxed”) position.

Still referring to FIG. 26, the exemplary ring structure 261 is configured differently than ring structure 234 of swivel connecting device 226 illustrated in FIGS. 22-25. For example, the exemplary ring structure 261 has a first section 262 cooperating with a second section 263. First section 262 has a first end 271 that terminates against or adjacent a second end 270 of second section 263 within the first portion 241 of opening 240. The termination of first end 271 against second end 270 establishes an intersection line 264. It should be understood that first end 271 can be spaced from second end 270. Exemplary ring structure 261 further includes a connecting tab 266 which connects first section 262 to second section 263 at rotation intersection 265. This configuration with the connecting tab 266 allows for first section 262 to rotate relative the second section 263 about connecting tab 266 described subsequently.

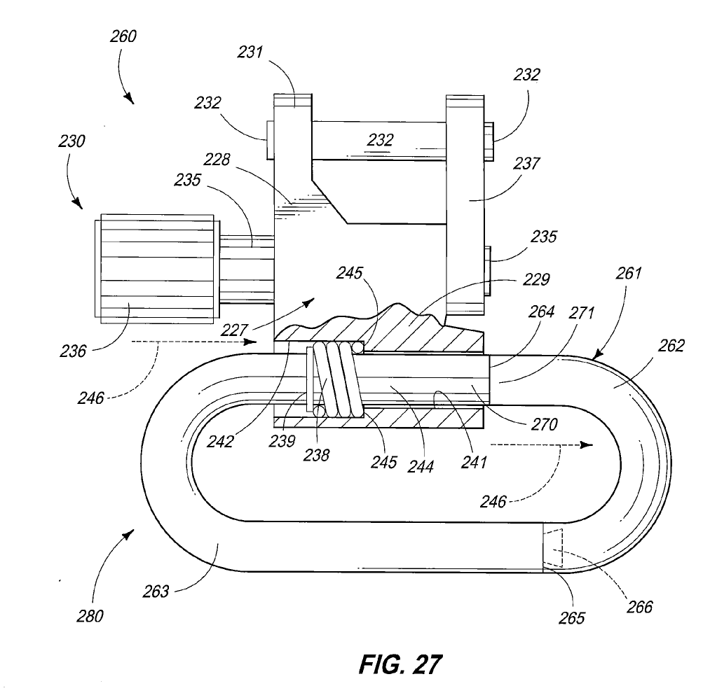

Referring to FIG. 27, and by a first exemplary method step, manipulation of ring structure 261 (for example, with a finger not shown) is implemented by applying a force on ring structure 261 in an axial direction 246 and moves ring structure 261 in axial direction 246. During this first method step, retaining collar 239 moves in the axial direction 246 against spring 238 further into opening 240 to compress spring 238 toward shoulder 245. When ring structure 261 moves a great enough distance, intersection line 264 will exit the first portion 241 of opening 240. In this position, the ring structure 261 and the second interlocking mechanism 280 of swivel connecting device 260 can be termed as being in the “pre-open” or “pre-unlocked” position.

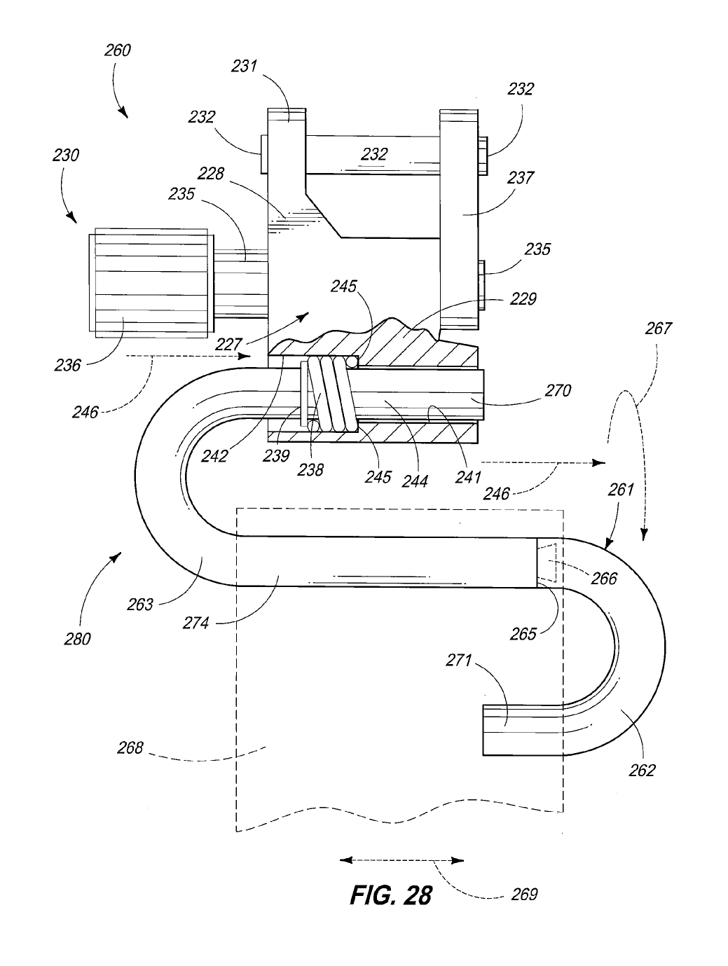

Referring to FIG. 28, and while maintaining the “pre-open position” by continuing to apply the force on ring structure 261 to counteract or oppose the biasing force of spring 238, an exemplary second method step can be performed. The second method step includes rotating first section 262 about connecting tab 266 along rotation direction 267. Accordingly, first end 271 of first section 262 rotates away from second end 270 of second section 263 to rest below an entirety of the structure of second section 263. In this position, the ring structure 261 and the second interlocking mechanism 280 of swivel connecting device 260 can be termed as being in the “opened” or “unlocked” position.

Still referring to FIG. 28, flexible material of an exemplary strap 268 for any exemplary body securement apparatus described previously can be provided having a loop (not shown) at the end of strap 268. In an exemplary third method step, the exemplary loop of strap 268 can be moved along direction 269 to be positioned for slipping or sliding over first end 271 of ring structure 261. The exemplary loop of strap 268 is continually moved in a sliding fashion over the first section 262 of ring structure 261 and ultimately moved to slide over the second section 263 and to rest upon a lower segment 274 (in this view) of ring structure 261. Accordingly, with this third method step, strap 268 of the any exemplary body securement apparatus is provided onto the second interlocking mechanism 280 of swivel connecting device 260.

Still referring to FIG. 28, as an exemplary fourth method step, includes rotating first section 262 about connecting tab 266 along rotation direction 267. Accordingly, first end 271 of first section 262 rotates toward second end 270 of second section 263 to again be positioned against or adjacent the second end 270 of second section 263 and to again establish intersection line 264. In this position, the ring structure 261 and the second interlocking mechanism 280 of swivel connecting device 260 can again be termed as being in the “pre-open” or “pre-unlocked” position.

Still referring to FIG. 28, and as an exemplary fifth method step, the biasing force applied in the direction 246 is withdrawn to allow the biasing force of spring 238 acting on retaining collar 239 to move ring structure 261 in the direction opposite to direction 246. During the movement of ring structure 261 in the direction opposite to direction 246, intersection line 264 of ring structure 261 reenters the first portion 241 of opening 240. In this fifth method step, the ring structure 261 and the second interlocking mechanism 280 of swivel connecting device 260 are returned to the “closed” or “locked” position. Accordingly, in the closed position, strap 274 of the any exemplary body securement apparatus is secured and locked onto the swivel connecting device 260. It should be understood that the first interlocking mechanism 230 of swivel connecting device 226 operates and functions the same as described previously for first interlocking mechanism 72 of the first swivel connecting device 50.

It should be understood that any one of the exemplary body securement apparatuses discussed herein could include a single strap or a single length of flexible material (instead of the two or more straps) with opposite ends. One end would have either a male or female element of a fastener and the other end would have the other of either a male or female element so the ends could be interlocked to form a loop of flexible material. A single length of single length of flexible material facilitates storage and handling.

It should be further understood that that any one of the exemplary body securement apparatuses discussed herein could be a single loop of flexible material without opposite ends.

It should be further understood that that any one of the exemplary body securement apparatuses discussed herein could have more than one connector, such as more than one swivel connecting device, slidingly engaging the length or loop of flexible material.

Moreover, it should be understood that that any one of the exemplary body securement apparatuses discussed herein can be positioned over at least one shoulder of an individual rather than over the neck and both shoulders of an individual as shown in FIGS. 9-10.

Furthermore, it should be understood that that any one of the exemplary swivel connecting devices discussed herein can have could have more than one ring structure.

Still further, it should be understood that that any one of the exemplary body securement apparatuses discussed herein having more than one exemplary swivel connecting device can have at least two of the swivel connecting devices being connected to different structures to be supported upon an individual's body.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A body securement apparatus comprising:
a length of flexible material configured to be supported upon a body of an individual;
a first connector comprising a first end spaced from a second end, the first end is secured to the length of flexible material and the second end is configured to be secured to a structure to be carried upon the body; and
a second connector comprising a first end spaced from a second end, the first end is slidingly engaging the length of flexible material and the second end is configured to be secured to a structure to be carried upon the body.

2. The apparatus of claim 1 wherein the length of flexible material comprises:
a first strap of flexible material comprising opposite ends; and
a second strap of flexible material comprising opposite ends, respective opposite ends of the first and second straps configured to be selectively interlocked to and released from each other.

3. The apparatus of claim 1 wherein at least one of the first and second connectors comprises a swivel connecting device, the swivel connecting device comprising:
a body;
a first interlocking mechanism slidingly engaging the body and configured to selectively provide closed and opened positions relative the body; and
a second interlocking mechanism slidingly engaging the body and configured to selectively provide closed and opened positions relative the body.

4. The apparatus of claim 1 wherein the length of flexible material comprises:
a first strap of flexible material comprising opposite ends, each end comprising a first fastener element; and
a second strap of flexible material separate and discrete from the first strap of flexible material, the second strap having opposite ends, each end comprising a second fastener element which is configured to be selectively interlocked to and released from respective first fastener elements.

5. The apparatus of claim 4 wherein the first fastener elements comprise the same design and wherein the second fastener elements comprises the same design, the second fastener elements configured to be selectively interlocked to and released from the first fastener elements.

6. The apparatus of claim 4 wherein the first fastener elements comprise different designs relative each other, wherein the second fastener elements comprise different designs relative each other, and wherein one of the second fastener elements is configured to be selectively interlocked to and released from one of the first fastener elements, and wherein the other of the second fastener elements is configured to be selectively interlocked to and released from the other of the first fastener elements.

7. The apparatus of claim 1 wherein the length of flexible material comprises opposite ends, each end comprising a fastener element configured to be selectively interlocked to and released from each other to establish a loop with the length of flexible material.

8. A swivel connecting device comprising:
a body;
a first interlocking mechanism slidingly engaging the body and configured to selectively provide closed and opened positions relative the body; and
a second interlocking mechanism slidingly engaging the body and configured to selectively provide closed and opened positions relative the body.

9. The device of claim 8 wherein the first interlocking mechanism comprises the same design as the second interlocking mechanism.

10. The device of claim 8 wherein the first interlocking mechanism comprises a design different relative a design of the second interlocking mechanism.

11. The device of claim 8 wherein at least one of the first and second interlocking mechanisms comprises a ring structure.

12. The device of claim 8 wherein the first interlocking mechanism comprises a ring structure and the second interlocking mechanism comprises a rotation lever that provides the opened and closed positions.

13. A method for securing a structure to a body, the method comprising:
providing a length of flexible material comprising opposite ends, the ends configured to be selectively interlocked to and released from each other, the length of flexible material comprising first and second connectors, the first connector is secured to the length of flexible material and the second connector is slidingly engaging the length of flexible material;
positioning a portion of the length of flexible material over a portion of the body;
interlocking the ends of the length of flexible material together; and
securing a structure to at least one of the first and second connectors.

14. The method of claim 13 wherein the positioning occurs after the interlocking.

15. The method of claim 13 wherein the positioning occurs before the interlocking.

16. The method of claim 13 wherein the securing occurs after the interlocking.

17. The method of claim 13 wherein the securing occurs before the interlocking.
